(19) United States
(12) Patent Application Publication
(10) Pub. No.: US 2002/0005865 A1
(43) Pub. Date: Jan. 17, 2002

(54) System, method, and device for authoring content for interactive agents

(76) Inventor: Barbara Hayes-Roth, Atherton, CA (US)

Correspondence Address: RENA KAMINSKY, LUMEN INTELLECTUAL PROPERTY SERVICES, SUITE 110, 45 CABOT AVENUE, SANTA CLARA, CA, 95051, US

(21) Appl. No.: 09/738,275

(22) Filed: Dec. 14, 2000

Related U.S. Application Data
(60) Provisional application No. 60/172,415, filed on Dec. 17, 1999.

(51) Int. Cl. G09G 5/00

(52) U.S. Cl. 345/706

(57) ABSTRACT

A method for authoring content of a computer-controlled agent includes the steps of identifying a potential context of the agent to an author; receiving content for the agent in the potential context from the author; and storing the content such that it can be accessed by a run-time agent. The run-time agent uses the content to control behavior of the agent in an actual context that matches the potential context. Context is typically presented to the author via a graphical user interface that allows the author to enter content without having any technical understanding of the run-time engine or the system's computer code. When the agent is authored using the authoring method, it can interact with a user through dialogue and gestures that are specific to contexts defined by user input, internal states or events of the agent, or input from other systems. For example, the agent responds to user questions differently when in different moods, and the agent's moods change in response to user statements or actions the agent performs.

### CROSS-REFERENCE TO RELATED APPLICATIONS

This application claims the benefit of U.S. Provisional Application No. 60/172,415, filed Dec. 17, 1999, which is herein incorporated by reference.

### FIELD OF THE INVENTION

This invention relates generally to systems, methods and devices for developing computer and other media systems that interact with people, with one another, and with other computer controlled systems. More particularly, it relates to systems, methods, and devices for developing computer agents and characters that can interact with people, with other computer agents and characters, and with other computational or media entities.

### BACKGROUND ART

Recent developments in software technology support the creation of interactive agents that can interact with people, with one another, and with other computer-controlled systems. Some of these agents can interact in natural language, sometimes including speech input or output. Some agents may be “embodied” in animation and include animated gestures or expressions in their interactions. Some agents may perform their functions on web sites, in stand-alone applications, or in email. They may interact via desk-top or lap-top computers, telephones, hand-held wireless devices, or other communications media. Some agents may have personas, including a biography, personal data, emotional or other psychological qualities, etc. Some agents may perform particular jobs, such as customer service, sales assistance, learner assistance, survey administration, interactive messaging, game play partnering, entertainment, etc. They may interact with other computational entities, such as databases, e-commerce systems, web browsers, etc. It will be apparent to one familiar with these developments that interactive agents may exhibit a great variety of specific combinations of features and functions, not unlike the great variety of specific features exhibited by human beings.

It is possible to distinguish two component tasks in the development of interactive agents: software development and content development.

Software development creates the computer code that provides the basic computational functionality that will be available in principle to every agent run with that particular software Software development is usually performed by highly trained technical experts who produce code written in C++, Java, or another software language.

Content development creates the data that must be combined with the code in order to complete a particular agent. Content development may be performed by people with various talents and skills, depending upon the application and the content development tools available. In many cases, non-technical experts are best equipped to create the dialogue, social skills, interactive expertise, personality, gestures, etc. of a given interactive agent. However, with existing systems, content development must include specification, either explicit or implicit, of a substantial amount of the detailed logic that is characteristic of computer programming. As a result, non-technical experts must either acquire technical skills or depend upon significant support from technical experts, in order to convert the content they design into data that can be used by the agent software. Similar technical expertise is required to make changes to agent content following initial development. This approach to content development is expensive, inefficient, and ineffective.

What is needed is a method for content development for interactive agents that enables non-technical professionals to work directly and independently of technical experts in order to create the dialogue, social skills, interactive expertise, personality, gestures, etc. of interactive agents.

### SUMMARY

The present invention provides such a method by anticipating the abstract structure of prospective interactions between agents and their users, defining localized contexts within that abstract structure, and allowing authors to create content for each such localized context. These contexts may be defined in a variety of ways to map on to the conceptual structures non-technical experts bring to the job of content development, for example:

Creating responses to standard social questions a user might pose to the agent (e.g., How are you? Where do you live? Do you like movies?),

Setting up an agenda of goals the agent might have for a particular stage in the interaction (e.g., Chat about own pets; Ask the user if she or he has pets; If so, ask for their names and animal-types; Offer to send a pet-food coupon; If user accepts, request email address),

Specifying alternative dialogue and gestures for different agent moods (e.g., saying goodbye to the user while feeling happy versus sad).

Specifically, the present invention provides a method for authoring content of a computer-controlled agent, with the following steps: identifying to an author a potential context of the agent; receiving from the author content for the agent in the potential context; and storing the content such that it can be accessed by a run-time system that uses the content to control the behavior of the agent in an actual context that occurs during operation of the agent and that matches the potential context. The authored content can be a persona, application, or role of the agent, or may relate to natural language conversation in which the agent engages. Specific instances of content can refer to dialogue delivered by the agent, gestures, mood changes, precondition values, interactions of the agent with external systems, and an agent's itinerary or agenda.

Potential contexts include user inputs during operation of the agent, an internal event or state of the agent, or an input from a different computer-controlled process. All of the potential contexts can refer to an agent-mood of the agent, an assumed user-mood of the user, messages between the agent and user, other computer applications, actions performed by the agent, an itinerary of the agent, or chat topics known by the agent. Potential contexts can be identified by the user or for the user, preferably in a graphical user interface that contains menus, labeled slots, gesture tables, symbolic indicators, and icons representing functions.

### BRIEF DESCRIPTION OF THE FIGURES

FIG. 1 shows a particular interface, the Imp Character Editor, in which agent content is entered.

FIG. 2 illustrates the top level of the Imp Character Editor.

FIG. 3 shows 14 built-in moods of the Moods section of the Editor.

FIG. 4 shows the Mood Screen for the mood Excited.

FIG. 5 is a mood diagram showing where each mood lies in a Wellbeing-Energy plane.

FIG. 6 shows the Mood Screen for creating the mood Despondent.

FIG. 7 shows the Mood Testing feature.

FIG. 8 shows built-in gestures of the Gestures section of the Editor.

FIG. 9 illustrates entering a new keyword in the Character Global section.

FIG. 10 shows the Keyword Properties screen.

FIG. 11 shows the Keyword Sharing form.

FIG. 12 illustrates creating a new token group.

FIG. 13 illustrates making entries in a new token group.

FIG. 14 shows the Backstory chat topic.

FIG. 15 shows the Multiple Dialog screen.

FIG. 16 shows the Single Dialog screen.

FIG. 17 shows Preconditions grouped under a subnode.

FIG. 18 illustrates making dialog dependent on mood.

FIG. 19 illustrates setting a mood to change in response to a keyword.

FIG. 20 illustrates making entries into the word group #User.

FIG. 21 illustrates selecting a Stop using Go To Stop.

FIG. 22 illustrates a new Web Guide Application with one stop.

FIG. 23 is a block diagram of an authoring system containing the agent editor of the present invention.

### DETAILED DESCRIPTION

Although the following detailed description contains many specifics for the purposes of illustration, anyone of ordinary skill in the art will appreciate that many variations and alterations to the following details are within the scope of the invention. Accordingly, the following preferred embodiment of the invention is set forth without any loss of generality to, and without imposing limitations upon, the claimed invention.

The present invention provides a method for authoring interactive computer-controlled agents. An author enters content information that will be accessed by a run-time engine at a later time to operate the interactive agent. An important feature of the invention is that all content provided by the author is correlated with at least one particular context in which the content will be use. Each potential context is provided to the author (or selected by the author) so that he or she can enter the content information without having any knowledge of the underlying mechanism by which the run-time agent uses the content.

The following terms are used throughout this description:

A context of an agent is a combination of a plurality of alternative values for each of a plurality of state variables of the agent, where the values of the state variables co-occur, either simultaneously or in sequence, during an operation of the agent.

A potential context of an agent is one that is identified prior to a particular operation of the agent and which may or may not occur during the particular operation of said agent. Potential contexts can be identified for the author or by the author.

An actual context of an agent is one that does occur during a particular operation of the agent.

A given actual context of an agent matches a given potential context of the agent if a value of a state variable in the given actual context matches a value of a corresponding state variable in the given potential context.

Content is any information that can be used to control an agent's behavior during operation. Content includes, but is not limited to, a line of dialogue, a symbolic gesture, a mood change, storage of data in a database, reading data from a database, a command to drive a browser, a specification of an animation, a specification of a browser, or a timing specification.

A simple example of the invention is a context of an agent Izzy based on values of two state variables, IZZY MOOD and USER INPUT.

IZZY MOOD is of the form: Sign Mood-Name

Sign can be one of: Not or blank

Not→complement of Mood-Name

Mood-Name can be one of: Happy or neutral or angry or furious or any

Any→happy or neutral or angry or furious

Furious→angry or furious

USER INPUT is of the form: Sign Prefix X

Prefix can be one of: What-is or Any-mention-of

What-is can be: What . . . is . . . X . . .

Any-mention-of can be: . . . X . . . .

. . . can be: any sequence of 0 or more words

X can be #catnip

#catnip can be one of: catnip or cat nip or plant . . . cats like

Examples of 4 Potential Contexts (PCs) of the Agent Izzy

| | IZZY MOOD | USER INPUT |
|---|---|---|
| PC1: | Not Angry | What-is # catnip |
| PC2: | Angry | What-is # catnip |
| PC3: | Any | Any-mention-of # catnip |
| PC4: | Happy | Any-mention-of # anything |

Examples of 5 Actual Contexts (AC) of the Agent Izzy

| | IZZY MOOD | USER INPUT |
|---|---|---|
| AC1: | Neutral | What in the world is cat nip? |
| AC2: | Furious | What the heck is that catnip stuff? |
| AC3: | Happy | I would like to get some of that plant that cats |
| | | like. |
| AC4: | Happy | I have a big black cat. |
| AC5: | Happy | Where is the game area? |
| AC6: | Furious | Where is the game area? |

Examples of Matches between Actual Contexts and Potential Contexts of the Agent Izzy

| | | | | | |
|---|---|---|---|---|---|
| AC1 | matches | PC1 | - - - | PC3 | - - - |
| AC2 | matches | - - - | PC2 | PC3 | - - - |
| AC3 | matches | - - - | - - - | PC3 | PC4 |
| AC4: | matches | - - - | - - - | - - - | PC4 |
| AC5 | matches | - - - | - - - | - - - | PC4 |
| AC6 | matches | - - - | - - - | - - - | - - - |

t,0072

Example of Content authored for 2 Potential Contexts of the Agent Izzy

| | IZZY MOOD | USER INPUT |
|---|---|---|
| PC1: | Not Angry | What-is # catnip |
| Authored Content includes 4 elements: | | |
| 1. Set User_Mentioned Catnip = True | | |
| 2. Increase User_Curiosity Slightly | | |
| 3. Perform Gesture = Talk | | |
| 4. Say one of the following, with Probability p: | | |
| a. “A feline's favorite controlled substance!” p = .1 | | |
| b. “A cat's idea of the perfect martini!” p = .1 | | |
| c. “A one-way ticket to feline frenzy!” p = .1 | | |
| d. “Pure Heaven, # User!” p = .7 | | |
| PC2: | Angry | What-is # catnip |

```
Authored Content includes 4 or 5 elements
(element 5 only in the context of Say 4c):
1. Set User_Mentioned_Catnip = True
2. Increase User_Curiosity Slightly
3. Perform Gesture = Talk
4. Say one of the following, with Probability p:
      a. “A cat treat.” p = .4
      b. “Something cats like.” p = .4
      c. “What do you care, # Bad_User_Nickname” p = .2
          5. Increase Izzy Rude_to_User Slightly
```

Typically, the invention is implemented with many more potential contexts based on more than two state variables. An example of a more realistic application, the Imp Character Editor, is described below for use in authoring a particular agent, an Extempo Imp Character. Extempo Imp Characters carry on conversations with humans using natural language technology. The Imp Character Editor allows complex Imp Character Natural Language Understanding (what the Imp Character will understand) and Natural Language Generation (what the Imp Character will say in response) to be authored. An Imp Character Editor is an interface to a database. It identifies a potential context of an agent to an author, receives input from the author, and stores the content in a database. It is to be understood that the Imp Character Editor example is for illustration purposes only, and in no way limits the scope of the invention.

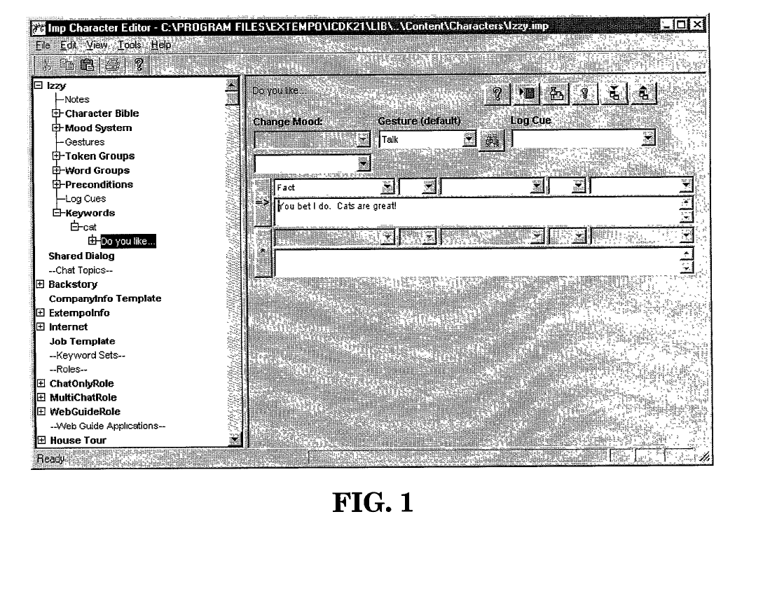

FIG. 1 illustrates a particular interface, the Imp Character Editor, for providing agent context to an author. The left pane of the interface contains a tree that indexes all of a character's information, while the right pane is the “work surface” in which authors enter and customize keywords and dialog. That is, the left side provides a structure of potential contexts, and the right side provides an interface in which the author enters content for a selected context. In this particular example, an agent, Izzy, has a number of potential contexts for which content can be defined by the author. The highlighted phrase, “Do you like,” is a value of a state variable representing words input by a user. If, during operation of the agent, an actual context occurs in which a user asks Izzy whether he likes cats, the potential context shown is matched, and Izzy will respond with the authored content, “You bet I do. Cats are great!!” Note that the author does not need to know any of the surrounding actual context in which the agent's response will be given.

The Imp Character Editor provides agent context in a graphical user interface with a structural layout. However, the invention can be implemented using any presentation method including, for example, auditory media.

Basic Terms and Concepts

The following terms are specific to the Imp Character Editor and are used in reference to this particular illustration of the invention. A character is a particular example of an agent. It is to be understood that the use of the word character in no way limits the scope of the invention.

ImpEngine. The ImpEngine is the run-time application that allows an Imp Character to carry on a conversation. It accepts and matches input from the user against the framework you create when you author a character, and then produces appropriate output from the framework.

Imp Utterance. An Imp utterance is something the Imp Character says. Every piece of dialog a character speaks is an Imp utterance. Single Imp utterances can be terse: “Don't think so;” or only part of a longer story sequence: “Let me tell you what happened to my friend Bob last week . . . ”

User Utterance. A user utterance is something a person interacting with an Imp Character says. A single user utterance is composed of the words entered when the user types into the Imp Character's text box, then hits Send or Enter. “How are you, Izzy?” is an example of a user utterance.

Log. All interactions between a user and an Imp Character are recorded. A log contains all of the Imp and user utterances as well as technical information such as the cues and gestures that are associated with each utterance. Logs are not terribly human-readable and are “stripped” into transcript form using the Extempo Log Analyzer.

Transcript. A transcript is the human-readable form of a log. It contains a complete record of the things said in a conversation between an Imp Character and by the user.

Natural Language Understanding, or NLU, refers to the way a character understands what a user said. Extempo's NLU technology at its most basic level is based on matching user utterances to word patterns that an author anticipates and creates in the Editor. Every word pattern a character is meant to understand is part of its NLU. NLU is case-insensitive and highly customizable. There are two kinds of NLU, built-in NLU and custom NLU.

Built-in NLU refers to the generic keywords and phrases that are automatically available to and understood by every Imp Character. They include common words that mean the same thing, like the names for different colors (found in a Token Group called #kindOfColor), or other common words that constitute topics for conversation, like “TV,” “Who are you?” etc.

Built-in NLU is available to you as you construct your custom NLU, but its constituents are not visible in the tool. Much built-in NLU constitutes every Imp Character's chat topics.

Custom NLU refers to special words and phrases added by a character's author. Custom NLU is an example of a potential context defined by the author. They can be single words, or when token groups are included, can include built-in NLU to make more complex patterns. Each author adds specific words and phrases so that their character will understand them. Examples of custom NLU are the keyword “purr” added to a cat character, or the keyword “reindeer” added to a Santa character. Here also is an example of a keyword pattern that incorporates a built-in NLU token group: Are your reindeer #kindofColor?

When a user's input matches a piece of NLU, the Imp Character will respond with the related piece of dialog. This is Natural Language Generation (NLG). A piece of dialog is an example of authored content.

Natural Language Generation, or NLG, refers to the dialog a character will speak when a user utterance (an actual context) matches a word or phrase in its NLU (a potential context). Every line of dialog you write is part of NLG.

Natural Language Understanding and Natural Language Generation (NLG) are inextricably linked—keywords generally lead to some form of dialog to speak when the character receives a particular input. The bulk of a character usually exists in custom (not built-in) NLU and associated NLG. Without custom language understanding and generation, your Imp Character could not have special interests, knowledge, or intelligence.

Entering Basic Content

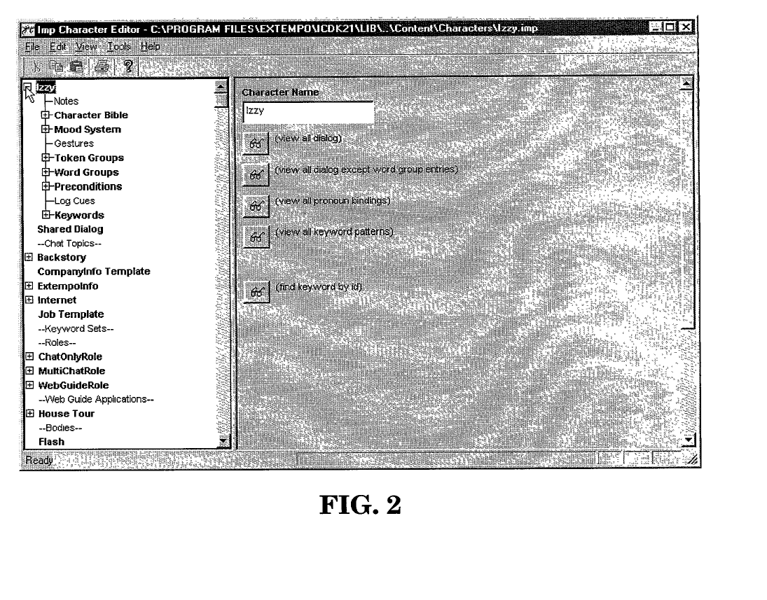

FIG. 2 illustrates the top level of the Imp Character Editor. Expanding the top level of the tree reveals contexts that are applicable to the character at all times. These include global properties that can be set or modified.

It is highly recommended that you do extensive planning before you begin work on your character inside the Editor. Typically the creation of a “character bible” entails a description of the character's backstory, some sample dialog so you can pinpoint the character's voice, and a description of what the character looks like physically. Once you have written these, you can paste the relevant sections into the Backstory Description and Sample Dialog boxes, and use the provided button to select an image for the Physical Description from a local drive. That way, any future writers will be able to quickly get a feel for your character: its personality, what it might talk about, and how it might talk about it. You will also find it easier to author your character when you have its motives and characteristics laid out in advance.

Imp Characters have the capacity to have moods that change based on their interactions and regress to “normal” based on their personalities. Like humans, they can anger when insulted and brighten up when praised. An agent mood is a component of a variety of potential contexts. For example, potential contexts include user input that communicates a message about the agent's mood; a change in an agent mood; delivery of a message by the agent relating to the agent's mood; or simply the mood itself. A mood is often one state variable that makes up a context based on a number of state variables.

Moods can be emotions or manners. Emotions include active, depressed, ecstatic, mellow, tired, very happy, very sad, happy, sad, angry, depressed, content, surprised, excited, elated, furious, and neutral. Manners include aggressive, submissive, active, passive, friendly, shy, quiet, chatty, energetic, reserved, curious, indifferent, aroused, polite, rude, edgy, humorous, and knowledgeable.

The Imp Character Editor uses a Mood System to give an agent a unique style of emotional response. Using these functions, you can easily make your character quick to anger or quick to forgive, as well as build your own emotional states if you so desire. An advanced use of the Mood System might be to model the user's mood based on the words they use and then customize the interaction based on what you perceive is the user's state of mind.

Two mood dimensions are built into every character by default: Wellbeing and Energy. Wellbeing is the general way the character “feels,” and Energy is a measure of how energetic the character is. Different levels and combinations of these dimensions yield different moods.

You are already undoubtedly familiar with humans who are only briefly bothered by a cross word, but also with others who hold a grudge for a long while. Imp Characters can have these “personalities” as well. Regression Speed refers to how quickly a dimension returns to “normal” when affected. For example, setting Wellbeing's regression speed to Slow means that if a user comment affects its wellbeing, it will take a long time for Wellbeing to return to its normal state by itself. If the user insulted the character (and then did not do anything else to affect wellbeing for the rest of the interaction), the character's Wellbeing would take much longer to recover than it would if the regression speed was set to Fast.

If regression speed of either, or both, dimensions is set to None, the value of the dimension will be saved in a database at the conclusion of the interaction. If the same user returns to visit the character, the character will begin with that mood value instead of beginning in the “default” mood.

Under Mood Dimensions, you have the option of adding extra custom dimensions to your character and creating new moods under those dimensions, discussed below.

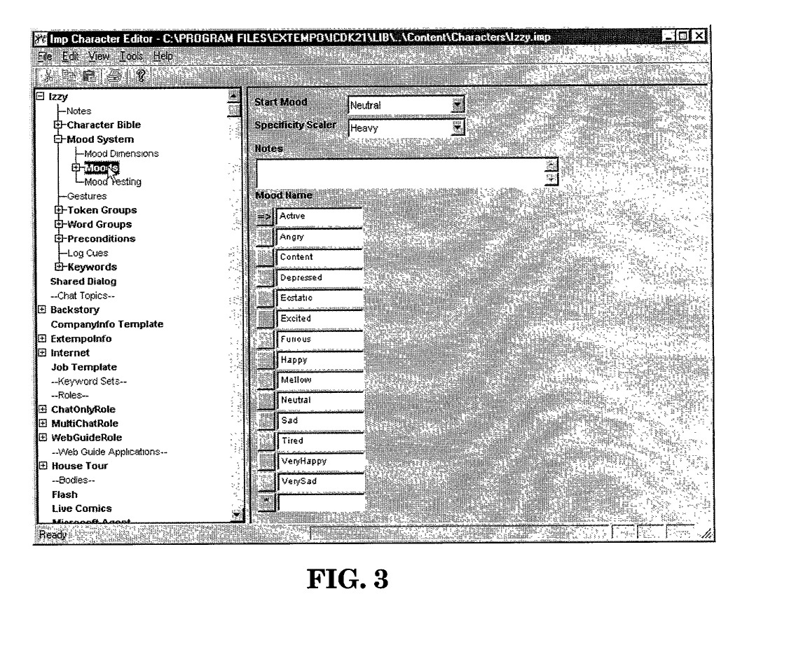

FIG. 3 illustrates a variety of potential moods. The fourteen possible moods already built into each character, listed in FIG. 3, are based on the two dimensions Wellbeing and Energy. Here is a brief explanation of how the moods are generated. There are six possible moods that stem from one dimension by itself. Four moods are based on the value of Wellbeing alone:

Wellbeing

| Very Low | Low | High | Very High |
|---|---|---|---|
| Very Sad | Sad | Happy | Very |
| | | | Happy |

Two moods are based on the value of Energy alone:

Energy

| Low | High |
|---|---|
| Tired | Active |

Combining the two dimensions yields seven more complex moods:

Wellbeing

| | | Very Low | Low | High | Very High |
|---|---|---|---|---|---|
| Energy | Low | | Depressed | Content | Mellow |
| | High | Furious | Angry | Excited | Ecstatic |

A final mood, Neutral, is at the middle of Wellbeing and the middle of Energy.

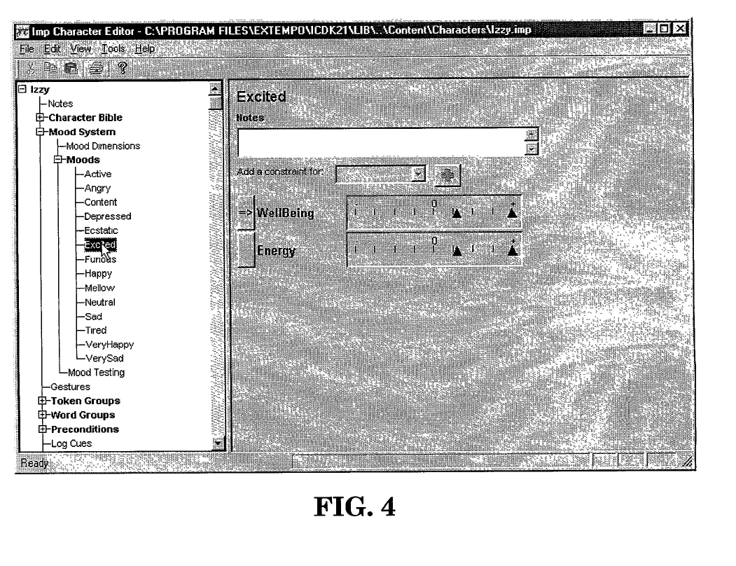

All of the 14 listed moods are fully customizable. When you click on one of these moods under the Moods section, the Mood Screen will appear on the work pane, as illustrated in FIG. 4. In each screen, you will see the name of the mood and the following options:

Add a Constraint For

If you had added any extra mood dimensions to your character, you can make any given mood constrained by that mood dimension by adding it here. Click the button to add the constraint, then select the dimension from the pull-down menu.

Wellbeing Range of Values

Customize the Wellbeing range of values using the sliders. A slider is a marker you move along a range of values. You can see the two triangles that function as sliders on each range of values for this mood. Using the Wellbeing sliders, you specify a range of wellbeing in which this particular mood applies. The two triangles are set to a default range when you first open a mood.

For example, opening up the mood Excited shows you that for the character to be Excited, the character's wellbeing must fall in the interval from about 1.2 tick marks to 4. If you would like the character to become Excited less frequently, you may make the interval smaller by moving the triangles closer together at the upper limit of the axis. Please note that the values of the tick marks are arbitrary, as there is no numerical scale on the slider—the ImpEngine actually calculates the numbers in a more complex way than what is seen.

Energy Range of Values

The Energy sliders function the same way as the Wellbeing slider.

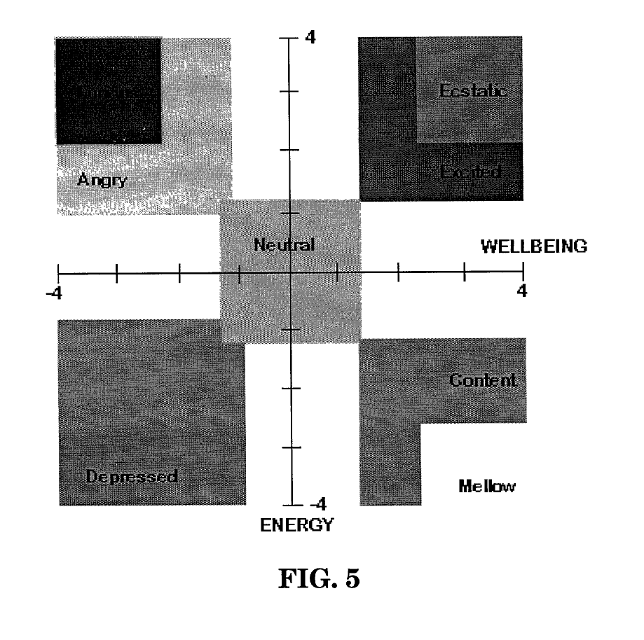

Some moods (like Active) are controlled only by the Energy slider, while some moods (like Happy) only use the Wellbeing slider. Other moods exist as an interaction between the two dimensions. It may be helpful for you to graph out your characters'mood dimensions and interactions on their axes so you can visualize how your moods interact and overlap. FIG. 5 is a mood diagram for the two-dimensional moods in the Imp Character Editor. Note that the values 4 and −4 are entirely arbitrary; only the relative areas of each mood and their positions on the plane are important. You can think of your character's mood as a point on the plane. When the interaction touches on topics that deal with mood, that point might move towards another area on the diagram. If the point moves into another square, there would be an actual change of mood.

As you can see from this diagram, some moods are subsets of other moods. For example, a character that is Furious is also Angry, but a character that is Angry is not necessarily Furious. The overlap becomes important when you are assigning mood values to dialog (described below).

Custom Moods

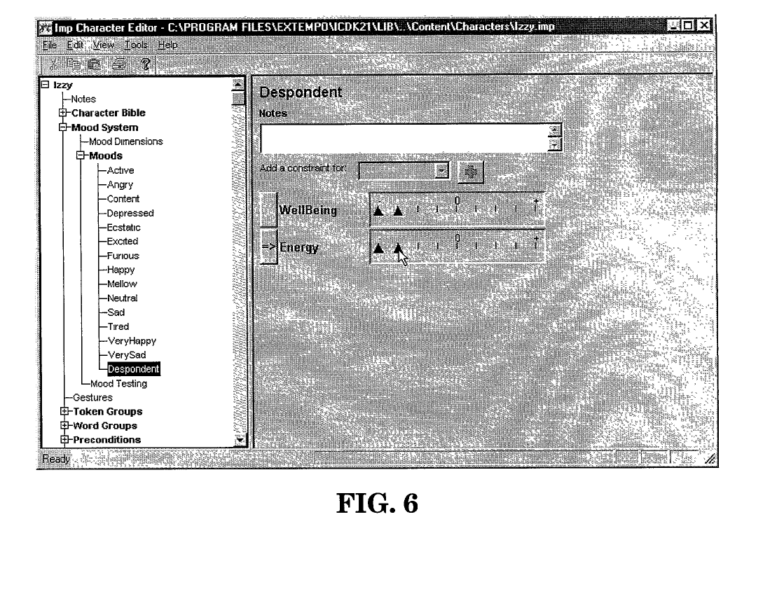

You can also create your own moods. For example, you might notice that in the Editor, there is no mood set to the default of Very Low Wellbeing and Very Low Energy. FIG. 6 illustrates the creation of the mood “Despondent” to cover this case. Enter the name of the mood into the first empty box under Moods, then go to its entry in the tree to set its slider values to very low.

You can also use custom moods in conjunction with a third dimension to track other things, such as aspects of the user. For example, you might add a third dimension “Car Savviness” to a car salesman character, and under it create moods “Not Car-Savvy” and “Car-Savvy.” Your NLG would then contain lines such that if the user used a specific car-savvy word (like “torque”), the character's “mood” would become “More Car-Savvy.” It could then use this mood to tailor its subsequent choice of words for the more car-savvy user.

Start Mood

In the pull-down box (FIG. 3), select a Start Mood for your character. All interactions with this character will begin with the character in that particular mood. Most characters start out at Neutral, but you can make a grouchy character always begin as Angry, while a nicer fellow might always begin as Content.

Specificity Scaler

The Specificity Scaler lets you indicate how important you want mood to be when your character is selecting what dialog to say. Five options are available in this pull-down menu. For example, at one point you might have three available pieces of dialog written for one keyword, to be used when the character is Happy, Ecstatic, or finally any mood in particular. Imagine that during a particular interaction, your character is Ecstatic when that section of dialog is triggered and the ImpEngine needs to pick a line to say. Because a character who is Ecstatic is also Happy (Ecstatic is a subset of Happy), all three lines are applicable. Specificity Weight helps determine which line of dialog it picks. If Specificity Weight is set to None, the character will pick randomly from the three lines. If Specificity Weight is set to Slight, the character will be slightly more likely to pick a line for the more specific mood, in this case, Ecstatic. If Specificity Weight is set to Linear, the chance for picking each line of dialog is inversely proportional to the mood's area. In this case, there would be a higher probability that the Ecstatic line would be picked. If Specificity Weight is set to Heavy, it will be much more likely to pick the line for the most specific mood. If Specificity Weight is set to Most Specific Only, the character will only pick the line with the most specific mood, in this case the Ecstatic line of dialog.

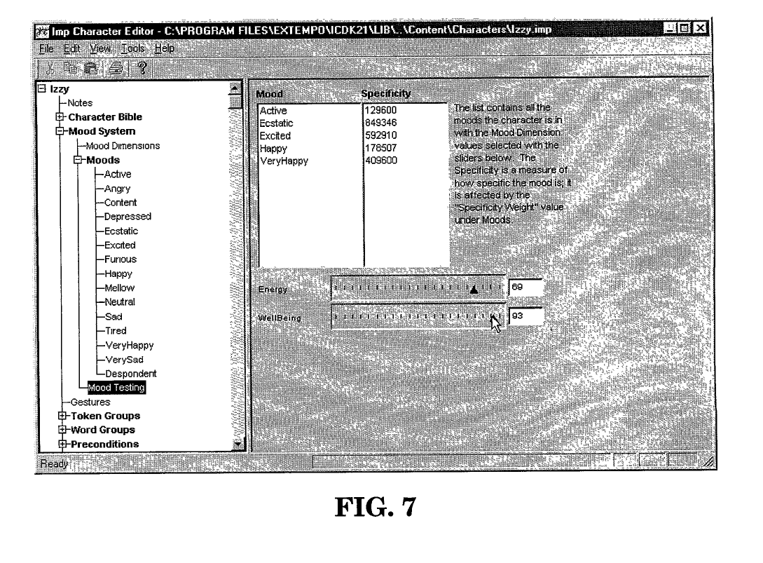

FIG. 7 illustrates the Mood Testing features, which lets you experiment with the Wellbeing and Energy values to see the moods that apply at various points on the sliders.

Move the sliders around to see the applicable moods. In addition, setting a Specificity Weight under Moods and then looking at various Wellbeing and Energy values under Mood Testing shows you what moods have what specificity, which is the relative weight a line of dialog with that mood would have. In this example, Specificity Weight was set to Heavy. If two lines of dialog for Happy and Ecstatic were available, the Happy line in this case would be weighted at 178,507 while the Ecstatic line would be weighted at 849,347, so the Ecstatic line would be about 5 times more likely to be selected. These numbers change depending on what was selected on the Specificity Scaler. If Most Specific Only is selected, the ImpEngine will only select the line with the greatest specificity.

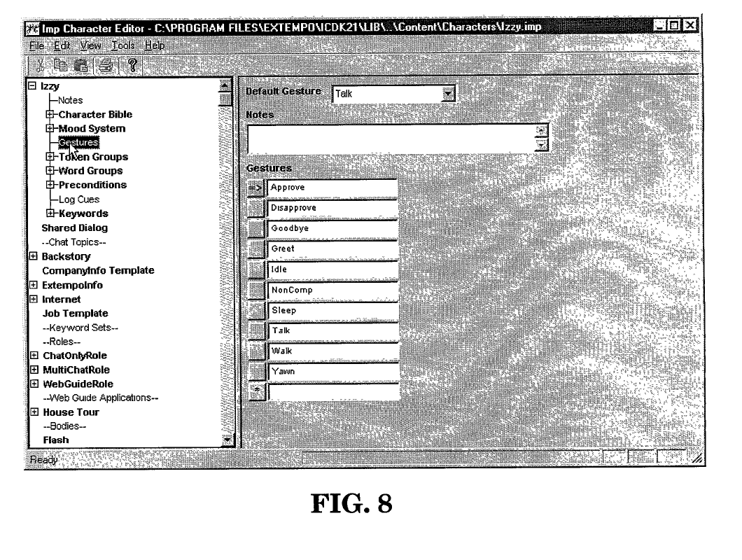

FIG. 8 illustrates gestures available to an agent. Gestures are an example of authored content and tell your character's image what to do physically when it says a specific line of dialog. Each line of dialog has one gesture associated with it. Gestures relate to the art you develop for each character, but not in a one-to-one relationship; there may be multiple images or animations associated with each type of gesture, in which case the ImpEngine will pick amongst them for one to display.

All lines of dialog begin with the Default Gesture until you change the selection individually. The Talk gesture is the most common gesture, so it is preselected to be the default gesture. You can choose another gesture to function as the default if you feel your character warrants it.

Approve. This is what the character does when it is pleased with something the user said. An approve gesture typically is a tacit acknowledgment of something the user said (e.g. the character nodding his head happily after the user said “I like you!”), rather than just the character looking happy.

Disapprove. This is what the character does when it is not pleased with the user. They should not look too mean as they may also Disapprove when they receive mild insults.

Goodbye. This is what the character does when the user says goodbye. This can be generic (a wave) or character-appropriate (a magician disappears in a puff of smoke).

Greet. When the character first arrives, they usually wave or make some acknowledgment of their arrival.

Idle. When the character is waiting for a response to a question and the user delays a while, the character may look away, file its nails, whistle, etc. However, it should not appear to ignore the user entirely. The point of the idle gesture is to give users the reassurance that the character is not staring them down at all times, and yet the gesture should also subtly cue them to resume the interaction.

NonComp. This is what the character looks like when it doesn't understand what the user said. Noncomp is short for “non-comprehended dialog.” Examples of things the character should do when it does not comprehend are: look confused, shake its head, etc. The character should do as much as possible (visually as well as verbally) to deflect blame from the user for the misunderstanding.

Sleep. When the user has not said anything for quite awhile, the character might “go to sleep.” Keep in mind that this doesn't mean every character should literally appear to go to sleep; users may find it somewhat rude when humans go to sleep in the middle of a task, for example. The “sleep” gesture can be something a character does, appropriate to its persona, which does not involve the user. However, it should still be obvious from looking at the character that it will not be rude for the user to “wake” the character and continue the conversation. The character should be doing something, but not something terribly important.

Talk. This is the most common gesture; it is something the character does when it's just talking. It can gesture vaguely around the page or just adopt a casual stance.

Walk. If your character is a tour guide, it can move from page to page by “walking” or otherwise indicating forward progress.

Yawn. This is what the character does immediately before falling asleep.

Other default gestures include agree, disagree, refuse, ask, explain, think, suggest, flirt, and look-confused.

Custom Gestures. You can add custom gestures into the blank box at the bottom of the Gestures list. Custom gestures are useful for making your character do something unique to that character. For example, Merlin's author added a custom gesture called Crystal Ball. When a line of dialog calls for this gesture, Merlin takes out his crystal ball and gazes into it. There is no limit to custom gestures save the extra download time extra images may impose.

A precondition is a further example of a potential context of an agent. Preconditions customize interactions based on what a character knows or has learned during the interaction, or what is stored in a database from a previous interaction. It is easier to create preconditions as you are writing dialog than to enter them here, but occasionally you will want to create your own preconditions by handcoding them. Once the preconditions are entered, you can use this part of the Editor to associate preconditions with a particular role or change the precondition's value.

Log cues are preconditions that are used to help catalog behaviors and topics of interest as they occur in real interactions. You attach log cues to specific lines of dialog as you are authoring. When a character uses a particular line of dialog with log cue attached in a real interaction, the ImpEngine writes the log cue into the raw log. Later, you can count the number of times the log cue occurs in a set of transcripts by using the Log Analyzer (see the Extempo Log Analysis Tools Manual), and perform a variety of analyses.

You create log cues in the top level of the character, but attach the log cues to single lines of dialog as you are writing. For example, you may have a character who works on a site that has a shopping page, which it sometimes invites users to visit. You may want to track your character's success at getting people to go to the page by putting a log cue on both the question and the response(s) to the user's answers.

Example (Cooperative user):

Character: Do you want to go to the shopping page? (Log cue: AskedShopping)

User: Sure

Character: Great, let's go shopping! (Log cue: TookUserShopping)

Example (Uncooperative user):

Character: Do you want to go to the shopping page? (Log cue: AskedShopping)

User: No

Character: OK, maybe later. (Log cue: NotTookUserShopping)

Later, you could divide the number of times the character did TookShopping by the number of times the character did AskedShopping to calculate the character's success rate for talking people into visiting the shopping page. (If the rate was low, you might want to reevaluate the character's persuasion techniques.)

The log cue system may sometimes seem cumbersome because log cues only attach to lines of dialog the character speaks, when sometimes it's the user utterance you're most interested in. Nonetheless, log cues are extremely important tools for tracking aspects of your character's conversation. You should map out areas of interest within your character, plan your log cues in advance, and begin adding them at a very early stage of character development.

Some log cues are built-in and are automatically attached to certain areas in the built-in chat topics. Use this section of the Editor to enter the names of custom log cues, which you will later use as you are writing dialog. You must also give each log cue a unique ID number in the ID box when you create them. Numbering them sequentially (1, 2, 3 . . . etc.) is fine.

Keywords

A keyword is a pattern that the Imp Character looks for in user inputs, i.e., a potential context in the which the value of a state variable is a specific word input by a user. Keywords can be as simple as one letter alone, or can be long phrases, patterns of words, or even full sentences depending on the author's needs.

Imp Characters need to recognize a wide variety of keywords and patterns so they can produce varied dialog in response, and also track and store various items of information. Authors add custom keywords (author-defined contexts) to give their characters breadth of knowledge.

Keywords appear in many places in the Imp Character Editor: in the top level of the character itself there are Character Global keywords, then there are progressively more specific keywords in Chat Topics, Web Guide Applications, and as After-Dialog Keywords (all discussed below). When you add keywords, the Editor provides a place for you to author custom responses to these keywords.

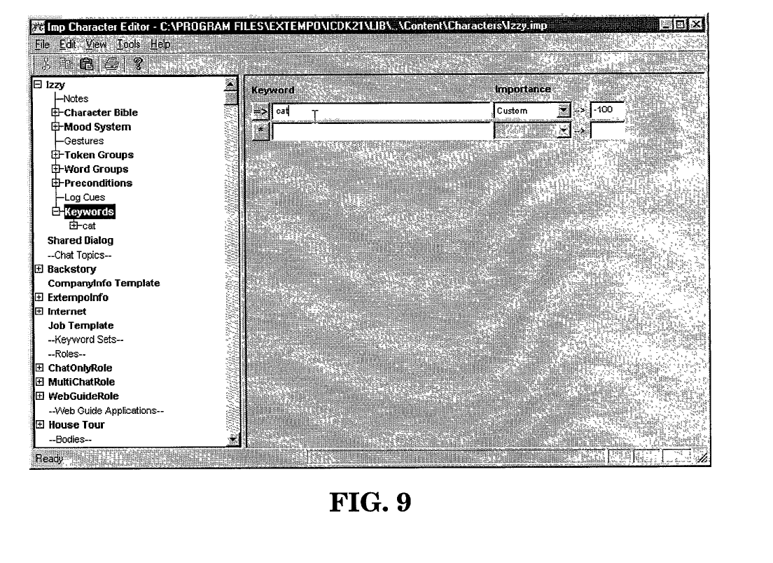

FIG. 9 illustrates one method of adding keywords into the Editor. Click on the bold Keywords heading in the chat topic or section of the Editor you are working on. If you are working with a new character, you may want to add new keywords to the Character Global section or the Backstory Chat Topic. The Keywords window will appear in the work pane. Type the new keyword into the first empty text box and press Return.

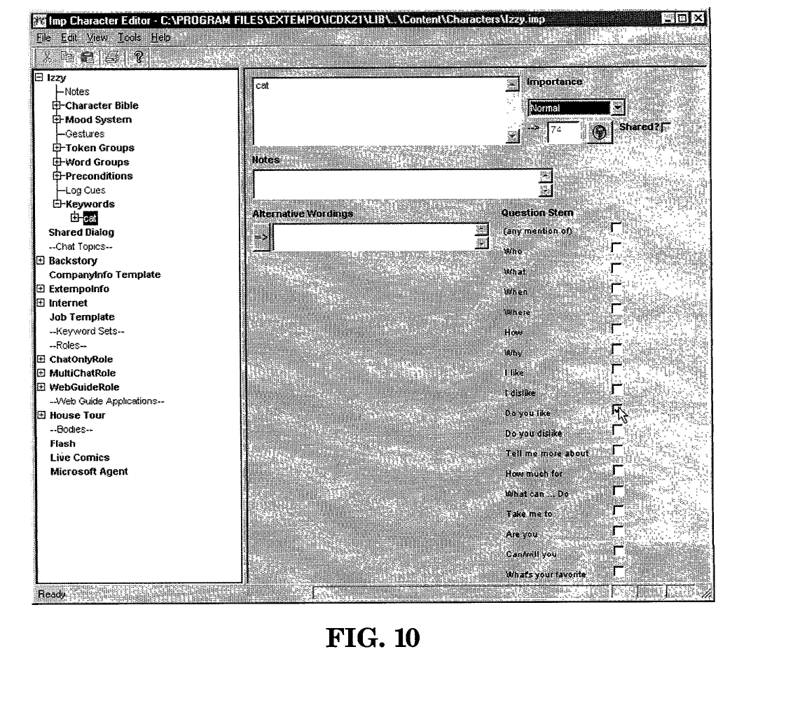

The keyword will now appear as a new entry in the tree below that particular Keywords heading. Clicking once on the new keyword in the tree opens up the Keyword Properties Screen, shown in FIG. 10, giving you the following options for how you would like your Imp Character to handle the keyword.

Setting a keyword's Importance lets the character choose which of several keywords to favor, in case a particular user input matches multiple keywords. For example, you might have two keywords, “Los Angeles” and “Los Angeles Times.” The words “Los Angeles” are contained within “Los Angeles Times.” If these two keywords have the same Importance and a user says “I like the Los Angeles Times,” the ImpEngine will match the shorter of the two; in this case the keyword “Los Angeles” would be triggered instead of “Los Angeles Times.” To correct this, make the importance of “Los Angeles Times” higher than “Los Angeles.” Doing this ensures that the character will “see” the longer keyword, and respond about the newspaper instead of the city.

Importance is also useful for directing the conversation to topics about which your character knows more. For example, if the words “house” and “Montana” were keywords with the same importance, and a user said, “My house is in Montana,” the character might choose randomly between the two keywords when picking what to respond to. However, you might want your character to be on the lookout for “Montana” because it knows a lot about Montana, and you think “Montana” is more interesting than “house.” Give “Montana” higher importance to make sure your character chooses the topic of interest. The more specific the topic, the higher the importance should be.

Different keyword areas in the Editor have different default Importance values. You can look at the importances of the keywords in different sections to get an idea of how specific different sections are considered to be. For example, the Character Global section's keywords have default importance 74 the Chat Topics keywords have default importance 84, and the Web Guide Application keywords have default importance 94.

Using the pull-down menu next to the keyword box, you can set the Importance of any keyword to Very Low, Low, Normal, High, Very High, or Custom. All Importance settings except Custom have a built-in number value. When you select Custom, simply enter a value into the box.

Keyword sharing lets you share authored keywords and dialog to different Keywords sections of the Editor. However, you should not use this feature if you want the keywords to have different functions in different sections of the Editor. If you share a keyword, any changes you make to the keyword and the corresponding dialog will automatically share to all of the other places as well. You should not share a keyword if you want to change its responses for one section and not for the other.

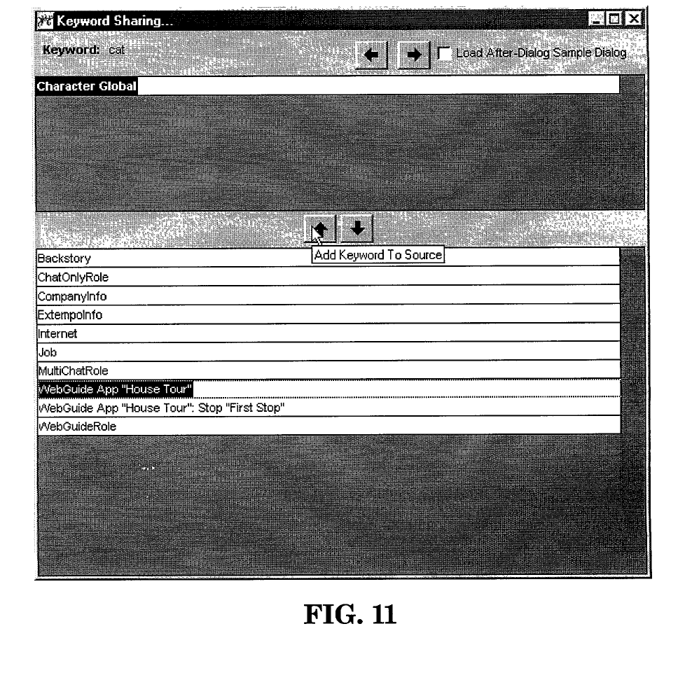

Clicking on the globe button accesses a form, shown in FIG. 11, that allows you to share keywords to multiple areas of the Editor. This is useful if you have a keyword authored in a very specific Chat Topic, for example, that you would like to make part of the global character keywords. When you use this form to share the keyword to another place in the Editor, the Editor shares the keyword and any associated dialog as well.

To share or unshare a keyword to any of the given areas, click on the area and use the Up or Down arrows to move it in or out of the upper part of the window. Keyword Sharing can become very tedious when you have a lot of keyword areas in your character, however, because you can add After-Dialog Keywords to any line of dialog, and all of those keyword areas will appear here as well. If you do have a lot of After-Dialog keywords and need to tell the keyword areas apart, clicking the small “Load After-Dialog Sample Dialog” box will load some dialog for those areas (this is not default because it can take some time).

Question Stems are predefined patterns of words that may occur in conjunction with a keyword. Some of them are common questions, like How . . . or Why . . . while some are statements, like Tell me more about . . . Checking one or more of these boxes tells your character to look for those patterns of words. With a keyword “catnip,” checking the box What tells the character to look for user inputs that contain the pattern “What . . . catnip” (with or without intervening words). A common user input that matches this pattern might be “What is catnip?” Checking the (any mention of) box ensures that your character always notices when a particular keyword is mentioned, even if it does not match any other question stem pattern. You should generally check this box for any keyword you author and add some dialog so the character will always have something to say.

Obviously, not all keywords make sense with all of the question stems. “Are you catnip,” for example, does not make sense. When you associate question stems, you only need to check the most logical boxes. Then you can author responses for each likely question. Look at your keyword and mentally evaluate how many of the available question stems make sense with this particular keyword. In the work pane, check the boxes for the most likely question stems. You will see a new entry appear in the tree below your keyword for each checked question stem.

Just as you would not check question stems that do not make sense with your keywords, make sure not to check question stems that don't make sense with all of your alternative wordings as well. You should try to use the question stems instead of duplicating them in your keywords—for example, use the “What . . . ” question stem instead of using “what is” in your pattern wherever possible.

Entering a number of alternative wordings or synonyms saves you from creating new keywords for similar concepts. For example, if you had a keyword “San Francisco,” you would want your character to understand common words and phrases that also mean “San Francisco,” such as “SF,” “s.f.,” and “Frisco.” You can enter each of these under Alternative Wordings so that your character will understand each alternate term as an equal match for the “San Francisco” keyword. (Of course, if you wanted your character to understand “Frisco” slightly differently from “San Francisco” so that it could comment “No one in California calls it that,” you could add “Frisco” as a separate keyword altogether.)

You should also use Alternative Wordings to help your character catch common misspellings of your keywords. A good example for “San Francisco” is “San Fransisco,” which is a misspelling you could probably expect users to make frequently. Adding common misspellings to Alternative Wordings increases your character's comprehension of real users'seldom-perfect typing.

You can add as many Alternative Wordings as you like to a keyword, but if you find yourself adding a lot of them, you may want to add them to a token group instead. Token groups, which are groups of related words or phrases, give keywords flexibility and depth while alleviating overuse of the Alternative Wordings feature. In general, token groups define a group of words that can all be treated as synonyms or members of a category. Token groups are then used as keywords or as parts of keywords.

For example, you could create a token group #miscPets and include in it these items: “cat&,” “dog&,” “hamster&,” etc. When the user says “hamster” or “hamster's,” the input will match keywords made with #miscPets like [any mention of] . . . #miscPets. This allows your character to know the user is talking about an animal that could be a pet, though it won't understand specifically which one. Still, your character can respond with general dialog about animals, instead of responding about hamsters in particular, and thus keep the conversation moving: “Speaking of pets, I just love cats.” With token groups, you won't have to create a special keyword for each group member unless you want to.

There are two types of token groups: Predefined Token Groups and token groups that you create from scratch.

Predefined token groups are mostly groups of common English words and phrases. An example of a predefined token group is #you, which contains the words “you,” “u,” “ye,” and “yerself” amongst others. Instead of creating an alternative wording with each of these options each time you make a keyword that requires the word “you,” using the token group #you in the keyword covers all of them at once. The more predefined token groups you use, the greater the chance that an utterance will match something you might not have otherwise considered adding. Inductive Authoring makes it easy to find matching token groups.

Some predefined token groups are capitalized, like #LAUGHS or #YES or #NO. These token groups are only supposed to be used as a full keyword, not in a phrase or a longer pattern. You can have the keyword #NO but not the keyword “#NO way Jose.” All Imp Characters understand predefined token groups, which you can use to build your keywords at any time. To use a predefined token group, simply type it as part of a keyword.

To complement the predefined token groups, you can create an unlimited number of custom token groups. They will contain words and phrases that your individual character will know and recognize. For example, if you had made the aforementioned special token group #miscPets for the abovementioned words, using the two predefined token groups #you and #like, you could then write a keyword #you #like #miscPets. Your character will then recognize the inputs “you like cats?” as well as “do u love cats?” and understand they mean the same thing.

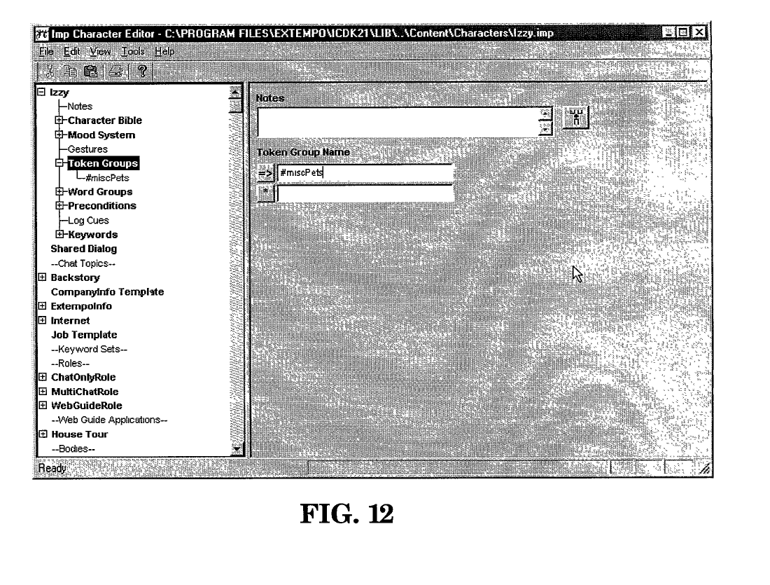

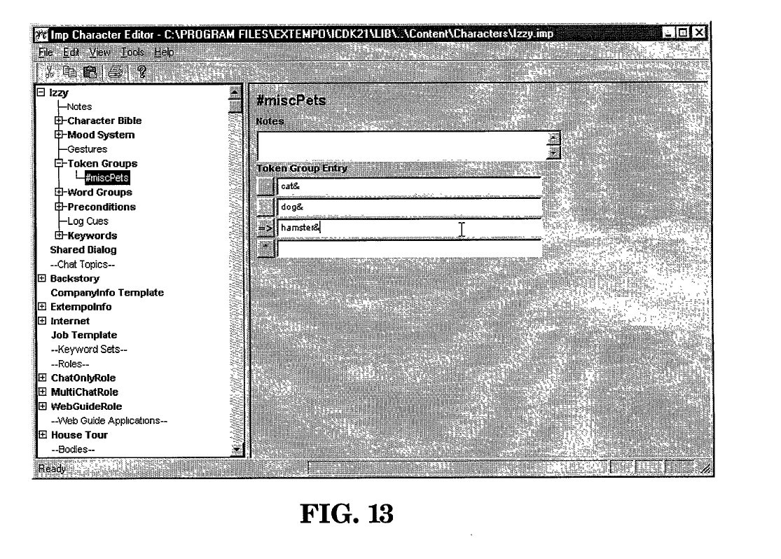

FIG. 12 illustrates how to create new token groups. In the top level of your character, click on the Token Groups heading. Enter the name of your new token group into the first empty box in the work pane (the name must be preceded by a # character). This will create a new token group entry in the tree. Clicking on the new tree entry provides a screen (FIG. 13) in which you can enter all of the words you wish to include in the token group. There is no limit to the number of entries in a token group.

Following the naming conventions used in the built-in token groups helps you keep track of the token groups you create. Synonyms are named after one of the common words. For example, #fast might contain “fast,” “quick,” “speedy.” Hyponyms are named #kindOfCategory. For example, #kindOfTree might contain “oak,” “elm,” “ash,” and “pine.” Token groups that don't fit either of those categories are named #miscSomething. For example, #miscWeather might contain “weather,” “cloud,” “rainstorm.”

User utterances that match a side effect keyword are recognized and evaluated, but the character does not say an authored response to the keyword. However, a different kind of content is authored for the potential context of a side effect keyword. This allows you to create “transparent” side effects such as mood shifts, stored variables, etc., all of which are considered to be content that partly controls an agent's behavior. An example of a side effect keyword that affects mood is #Insults. If a user said, “Tell me about New York, you moron,” the character would understand the comment about New York, but also know it had been called a moron, resulting in a mood shift. If you had a lot of mood-dependent dialog, it could potentially respond about New York in an appropriately testy manner.

The syntax for making a side effect keyword is including the tag <SIDEEFFECT> in the keyword: <SIDEEFFECT># Insults. You do not have to use the tag on the keyword's alternative wordings. When authoring dialog to “respond” to a side effect keyword, it must be in the form of a Fact (see below for discussion of Action Types). The dialog is not actually spoken, but nonetheless requires an action type.

Keywords can be simple, one word entries. Keyword annotations, however, allow you to create more complicated and more specific keywords, like patterns and phrases. The more specific your keywords, the more specific your Imp Character's understanding can be.

Consequently, your character will seem more intelligent in conversation. Here are the annotations you can use:

The three dots, or ellipsis ( . . . ), are used between words in the keywords when you want the Imp Character to recognize words even if they're not immediately adjacent. For example, you enter a keyword “my friend,” with no ellipsis. Without the ellipsis, the character recognizes the phrase “my friend” only if the words appear in that order and directly next to one another. The character understands the user's comment “I love my friend,” but not the comment “I love my best friend.” If the keyword is entered as “my. friend,” the character understands both comments. The ellipsis informs the Imp Character to only look for the words “my” and “friend” with any intervening words ignored.

The ampersand (&) is used to extend a keyword to cover plural and possessive forms. Entering a keyword “dog” will not cover the inputs “I love dogs” or “My dog's name is Rex.” Making the keyword “dog&” covers these inputs.

The character understands the word or words immediately following the @begin annotation if and only if they are at the beginning of the user's input. You can use this annotation to trap words that have one meaning if they appear at the beginning of an utterance but another meaning if they occur in the middle of a sentence. For example, if the keyword is entered as “@begin cool,” the character understands the comment “cool” (a brief pithy comment) but not “My teacher is really cool” (a fact to be comprehended).

The character understands the word or words immediately following the @end annotation if and only if they are at the end of the user's input. You can use this annotation to trap words that have one meaning if they appear at the end of an utterance but another meaning if they occur in the middle. The keyword “my friend here @end” would be an excellent way to catch the questions “Why is my friend here?” “Was my friend here?” or “Is my friend here?” while ignoring comments like “My friend here is an engineer.”

The @any annotation represents any single word (the ellipsis represents any number of words). Use it when there is a variety of words that might be expected that do not change the meaning of a phrase, but are required to be there. For example, perhaps your character's been talking about its friends. The user might refer to the character's friends as “you talked to those friends,” “you talked to these friends,” “you talked to your friends,” etc. Enter the keyword as “talked to @any friends” and the character will allow any word to appear between “to” and “friends.”

The @anyInteger annotation represents any single integer number. Use it when you expect a number, but don't know what it will be. Example: The keyword #I am @anyInteger years old would match the user inputs “I am 6 years old,” “I am 46 years old,” etc. (It will also catch “I am 2000 years old,” of course.)

Every character will have a large set of keywords. However, there is a tradeoff between the number and complexity of a character's keywords and the speed of the character's responses. Avoid adding keywords and alternative wordings just for the sake of having more keywords and alternate wordings. You should always have reason to believe that a new keyword or alternate wording will occur with some frequency in actual use.

Chat Topics are another component of a potential context. Chat Topics are essentially extensive sets of pre-authored keywords for an assortment of topics in which you can author custom dialog. Examples of chat topics include movies, art, shopping, animals, cleaning, music, sports, holidays such as Christmas or Valentine's Day, the Internet, a company, friends, people, the environment, and jokes. Like moods, chat topics are components of a variety of different potential contexts. For example, a user input can refer to a chat topic; an agent can deliver a message to the user referring to the chat topic; or an agent can have knowledge of a chat topic, including chat topics that were previously mentioned by the user or agent.

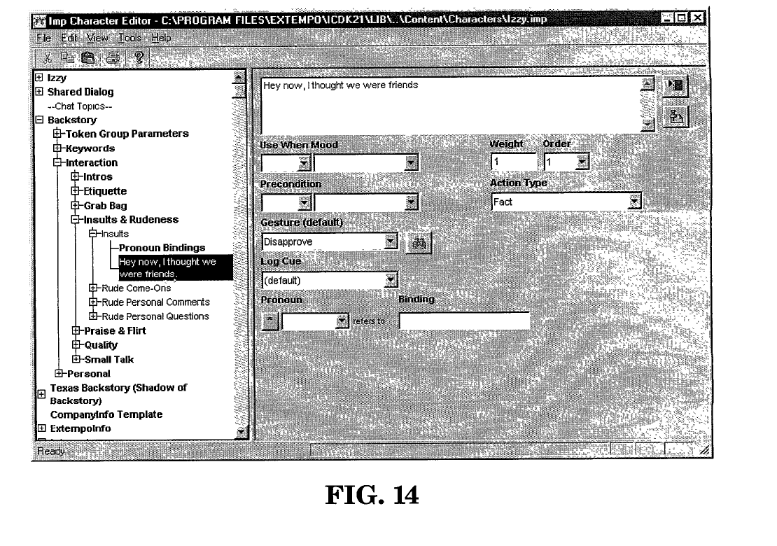

FIG. 14 illustrates an interface for entering a chat topic. The Backstory Chat Topic includes a section for Interaction containing a subtopic Insults and Rudeness, under which is a “keyword” -like heading labeled Insults. Behind Insults, not visible in the Editor, Extempo has compiled a large group of words and phrases that constitute insults (everything from “I hate you” to “Your mother wears army boots”). They are like keywords that you don't have to author yourself or change. Whenever a user utterance triggers one of those keywords, the character will understand that it has just been insulted. You fill in some dialog for the heading so that your character has an appropriate response like, “You sure know how to make me feel sad.”

All of the other keyword-style headings in the Backstory Chat Topic refer to similar lists of built-in words and phrases. Filling in every category in the Backstory Chat Topic gives broad coverage for your character's backstory, general manner of speaking and personality. Other available chat topics are the ExtempoInfo Chat Topic, the CompanyInfo Chat Topic, the Internet Chat Topic, and the Job Chat Topic.

Here are the formats for the text you will find in the Editor.

Brackets enclose generalizations of what the user might say: [I'm sorry.] User inputs that might match this heading are: “I'm sorry,” “My apologies,” etc. You fill in dialog that is the character's response to the user input. Quotation marks enclose generalizations of what the character's dialog should mean: “I like you.” An Imp utterance you could write for this heading might be: “I certainly do enjoy our time together, my friend.” Plain text denotes generalized topics of discussion: Movies. An Imp utterance you could write for this heading might be, “Speaking of movies, I liked Star Wars a lot.”

Some Chat Topics include a field for Token Group Parameters. Token Group Parameters pertain to “built-in” token groups that the particular chat topic uses within the NLU, but you must define the entries in the token groups for each character because the entries will vary. For example, in the Backstory, Token Group Parameters are only needed for the token group #impName. #impName should contain all the ways users might say the character's name. Since the token group #impName appears frequently in the behind-the-scenes “keywords” that make up a chat topic, the token group must be filled in. Filling the token group in can be as simple as creating one entry for the character's name, or it can be more complicated (for Cupid, you could make #impName include “Cupid,” “Eros,” “God of Love,” etc.).

When your character recognizes a keyword pattern in a user utterance, it needs something to say in response. That is, in the context of a particular word input from a user, the agent has particular dialog content.

Dialog

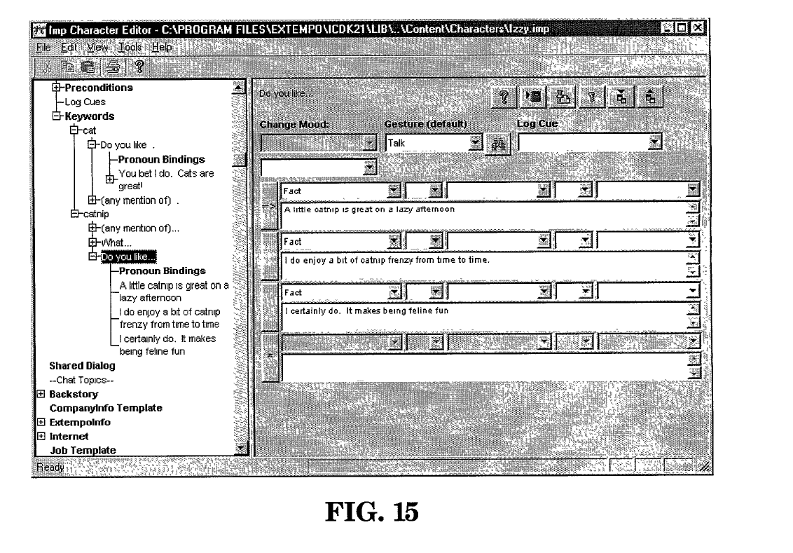

We have discussed how an Imp Character learns to understand user utterances by using keywords. Now, we will discuss how a character responds to user utterances with the appropriate Imp utterance, i.e. your authored dialog. Keywords, coupled with question stems, need lines of dialog to accompany them. FIG. 15 illustrates a Multiple Dialog Screen in which author content is entered.

Go to the Keywords section of the Editor, enter some keywords, and attach some question You will then see new entries appear in the tree below the keyword for each keyword-stems. question stem combination you created. For example, you may have entered the keyword “catnip” and checked the question stems (any mention of), Do you like . . . and Tell me more about . . . You will then see the following entries appear in the tree:

(any mention of) . . . catnip?

Do you like . . . catnip?

Tell me more about . . . catnip?

Click on any of these headings to begin entering dialog. If you click on Do you like . . . catnip? you will see the Multiple Dialog Screen appear in the work pane.

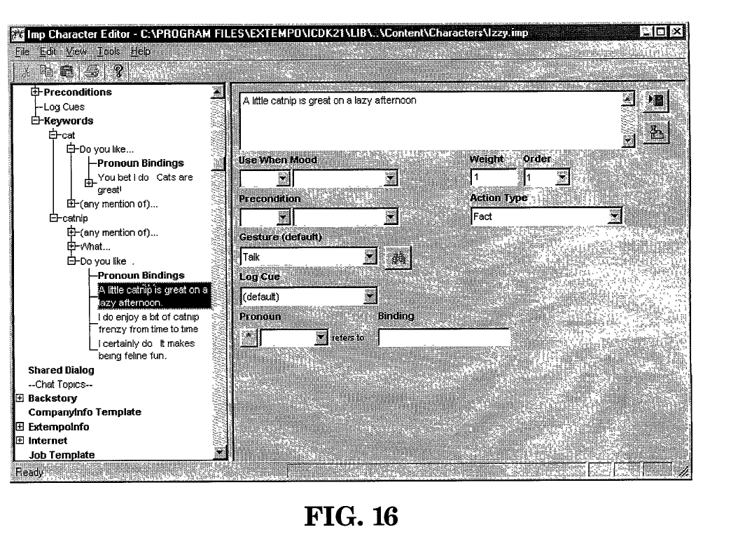

This screen is called the Multiple Dialog Screen because it has multiple large text boxes for entering and viewing multiple lines of dialog at once. Usually, you will write multiple variations on each line of dialog; all of them would be summarized in this screen. For now, begin by entering one line of dialog in your character. In the first large empty text box on the Multiple Dialog Screen, begin typing your character's response to this keyword-question stem combination. When you are done typing the dialog into the box, the line of dialog will also appear in the tree. Click once on the line, or double-click it on the Multiple Dialog Screen, to see it in the Single Dialog Screen, FIG. 16. Any time you are editing a line of dialog, you will be in either a Multiple Dialog screen or a Single Dialog screen. In the Single Dialog Screen, you can apply extremely specific settings to the one line of dialog shown. Here are the features of the Single Dialog screen.

Click the Make Shared Dialog button to turn the dialog you have just written into Shared Dialog. Shared dialog is dialog that you know you will be using in multiple places in a character. If you know you will re-use a specific line of dialog later in a character, making it shared dialog makes it available for repeated use without requiring you to type it in multiple times. You can view and edit all shared dialog in the Shared Dialog portion of the tree in the top level of the character.

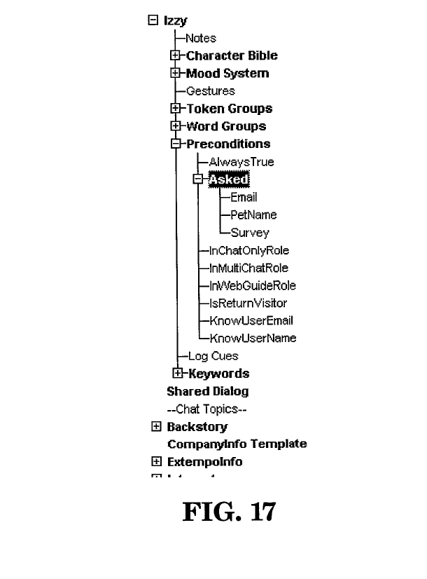

Recall that Preconditions may be triggered based on a character's actions during an interaction. The Create Precondition button (to the right of the main text box) creates a precondition that triggers when this particular piece of dialog is said. When you click on the button, you will be asked to name your precondition. Since the precondition activates when the line of dialog is used, name the precondition something that describes what this particular line of dialog is or does, i.e. Asked_UserAboutPets or Told_FishJoke. When the character uses this line in an interaction, it will automatically trigger this precondition (its default value is FALSE, so after it is triggered, it becomes TRUE). You can then use the Preconditions options as you are entering other dialog to control when and how a character might speak other lines based on the state of other preconditions. Preconditions grouped under a subnode are illustrated in FIG. 17.

You will sometimes write dialog that should only be used in certain mood circumstances. This dialog is entered in the Use When Mood boxes. Since users will only perceive your character's mood through the tone of its dialog, you should generally write different lines of dialog for different mood conditions. For example, in response to the keyword What . . . catnip, you could write several lines of dialog for different moods:

For general use:

Catnip is a plant that makes cats happy. I know I enjoy it.

If the character is happy:

Catnip is a wonderful, wonderful thing. It's terrific fun! I highly recommend it.

If the character is angry:

Catnip is a plant that some cats like. Not that you'd care, #User.

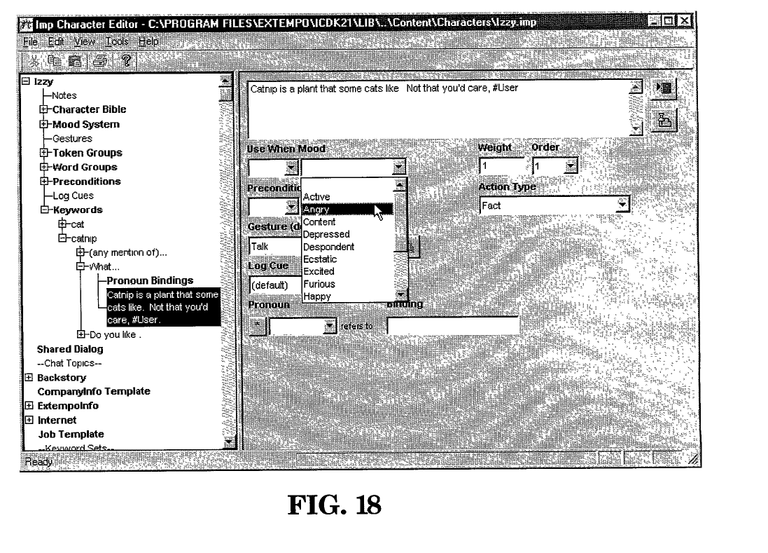

FIG. 18 illustrates the Use When Mood option, which should be set for each of these lines to make sure your character says the line of dialog at the right time. Using the pull-down menus, set Mood options for each line of dialog. The first pull-down menu is either blank or has the value Not. The second pull-down menu contains all of the moods your character can have, including any custom moods.

Most of the time, you will just use the second menu to select the mood the character must be in before it can speak this line. Less frequently, you will use the Not option to let a character use this line at all times except in a very specific case. For example, you could decide a particular line should come up when the character is Not Ecstatic; the line could still come up when the character was Happy, Angry, Sad, etc.

You should always write at least one line of dialog for each keyword that is not dependent on mood (i.e., nothing is selected in the Use When Mood boxes) so the character will always have something to say if its mood does not match the other lines. When you compile your character, the Imp Character Editor will let you know if there is a mood case in which there potentially might not be any lines to say.

Weight is a way for the author to give some dialog a greater chance to be spoken relative to other dialog under the same keyword. Most keywords will have multiple possible responses; you may want to favor some responses more than others. Dialog with Weight=2 will be twice as likely to be selected as dialog with Weight=1.

Use Order to set the order that the dialog should be used to answer similar user utterances. That is, if a user triggers a keyword once during an interaction and later triggers the same keyword again, the character will say any response dialog with Order=1 the first time and any dialog with Order=2 the second time the keyword comes up. Multiple lines of dialog can have the same Order value. The character will not start over with Order=1 after it reaches the last ordered response, however; it will continue to repeat dialog of the last sequential Order, which you may want to use as an opportunity for your character to say, “Sorry, that's all I know on the subject.”

Use the Precondition options to set parameters for when the character can use each line of dialog, based on preconditions'values when the dialog area is triggered. The first pull-down menu is either blank or has the value Not. The second pull-down menu has a list of all the existing preconditions in your character, both built-in and custom. Select one of them for your line of dialog. For example, if the line of dialog uses the user's name, the precondition Know_UserName would be appropriate.

You can also use preconditions to keep characters from repeating certain dialog like stories or jokes. If a joke about a fish is already set to trigger a precondition Told_FishJoke once it is told, setting the Precondition options on telling that particular joke to Not Told_FishJoke means it would only tell that joke if it had never told that joke before.

Each line of dialog has an Action Type, which lets the ImpEngine know how to make the character behave when each line is said. In the pull-down menu, you will see ten Action Types that can apply to a line of dialog.

A Fact is a statement the character says to the user. It requires no immediate answer or elaboration. The Imp Character will pause for a moment after saying a fact, and then move on to whatever it was going to say next.

The Action Type Yes/No Question tells the character to pause and look for either a Yes or No answer to that line of dialog, and follow up with an appropriate response for each. When you select Yes/No Question, new entries appear in the tree so you can fill in what the character should say when the user answers “Yes,” as well what it should say when the user answers “No.”

A Question is similar to a Fact, but after a Question the Imp Character will pause while it waits for the user's open-ended answer to the question. You should write keywords that permit the character to understand the likely responses to this question.

When a line of dialog is a Question w/Followup, the character poses the question, waits for a user response, then makes a followup comment. The followup comment is the same no matter what the user utterance “means.” For example:

Character: Yes, I love Los Angeles. How do you feel about L.A.?

User: Los Angeles is great.

Character: Everyone's entitled to their opinion.

The character will say the same followup comment no matter what the user says—be it “L.A. is great” or “I don't like it” or “I'm not telling you,” etc. In this case, the followup comment makes sense for all those replies—but this is not always the case with this type of dialog. Since the character will say the same thing no matter what the user says, author a fairly vague response. Obviously, you run the risk that the user will say something completely unrelated after the question and the followup will make no sense. You should use this action type extremely sparingly and try to make the questions extremely attractive ones. Most of the time, a character can get by with a plain Question in hopes that the user's response will match a keyword.

A Story is technically a series of linked Facts that the Imp Character speaks one after the other. After saying the first part of the story, it will give the user a few seconds to finish reading that fact, then move on to the next part of the story. When you select Story, a new heading called Next Step In Story will appear under that line of dialog in the tree, and a Delay box will appear in the work pane. Expand the Next Step in Story heading and enter some new dialog there as well. You can add as many steps to a story as you want, however, be aware that few users will get deep enough in your character to see more than three or four steps. Users can interrupt a character's story to ask questions or make statements. The character will attempt to return to the story the first and second time it is interrupted, then abandon the story if it is interrupted again.

When you select Story, a text box labeled Delay will appear below the Action Type box. The number you enter in this box is the minimum number of “ticks” (usually, ticks are seconds) that the character will wait when the behavior is completed before moving to the next item. For the LiveComics or Flash character, the behavior is generally instantaneously “complete,” as the words simply appear in the text box. For the MSAgent character, the behavior is not complete until the text-to-speech engine finishes saying the line. Adjust this number until the character is saying the line and continuing to the next one at the correct pace.

Selecting Shared as an Action Type makes a new pull-down menu appear underneath the Action Type box. This new menu contains the short names for the shared dialogs you have already created. From the menu, you can select one of your shared dialogs to be used here. If something is already entered into the text box, it will be deleted and replaced with the (shared dialog: DialogName) notation.

The remaining Action Types in the pull-down menu are only active in the Web Guide Role (discussed below).

To associate a gesture with a line of dialog, select the gesture from the pull-down menu. If you would like this line of dialog to be accompanied by a custom gesture that has not yet been added (is not in the menu), add the gesture in the top level of your character first. If you select a gesture that is not the default gesture, you have the option of setting Gesture Parameters for that gesture. Gesture Parameters provide extra instructions for the character and are particular to the different body types. Some examples of Gesture Parameters are MSAgent_X and MSAgent_Y, which instruct an MSAgent character to move to certain X or Y coordinates on the screen; and ImpTalk_URL, which instructs a StraightTalk character to open the URL you specify when it performs this “gesture.”

To add a Log Cue to a line of dialog, enter the names of log cues in the top level of the Editor, then select one of your log cues from this pull-down menu. Each time the character uses the line of dialog, it will be “tagged” with a log cue in the raw log. Later, you can use the Log Analyzer to analyze the logs and calculate various statistics related to log cues.

Imp Characters can understand pronouns in context if you bind them properly using this feature. In natural conversation, humans use pronouns to refer to things that have already been named. Pronoun binding allows characters to converse more naturally. If Izzy were to say “I do enjoy a bit of catnip frenzy from time to time,” the user could have any number of responses containing pronouns. For example, the user might say, “Why do you like it so much?” or “What happens when you do that?” or “I want to buy some.” Using Pronoun Binding, you can ensure that the character will understand each of these inputs.

At runtime, when the character says this line of dialog, the ImpEngine loads the binding information and will automatically look for any matching pronouns in the responding user utterance. The ImpEngine will substitute the bound keyword(s) for the selected pronoun(s), and then finally run the user input through the NLU. The character will “understand” that the user said the bound word.

Recall that the Multiple Dialog Screen (FIG. 15) is the screen that shows all the possible lines of dialog for a particular keyword-question stem combination. Here are the features of the Multiple Dialog Screen, which should be familiar after you have some experience with the Single Dialog Screen. The Multiple Dialog Screen shows all of the lines of dialog that pertain to a particular keyword-question stem combination or heading, not just single lines by themselves.

The Create Precondition button creates a precondition based on the selected dialog (same as before).

The After-Dialog Keywords button creates a new Keywords level in the tree attached to the keyword-question stem combination you entered. Any keywords you enter here are referred to as After-Dialog Keywords because they are only active immediately after the character speaks any of the lines of dialog pertaining to this particular keyword pattern, then are made inactive again after the next utterance.

After-dialog keywords are useful for trapping general keywords that occur at specific points in the interaction. In the above example, you can imagine that the single word “why” would not be very useful as a general keyword. However, if the user said “why” immediately after this line of dialog, you could assume that the user was asking why Izzy likes catnip so much. After entering these keywords, you can write specific dialog for them.

You can also use after-dialog keywords to respond to “Yes” or “No” in cases where an explicit Yes/No Question would be unwarranted (for example, when the character makes a rhetorical question—because inevitably, someone will answer).

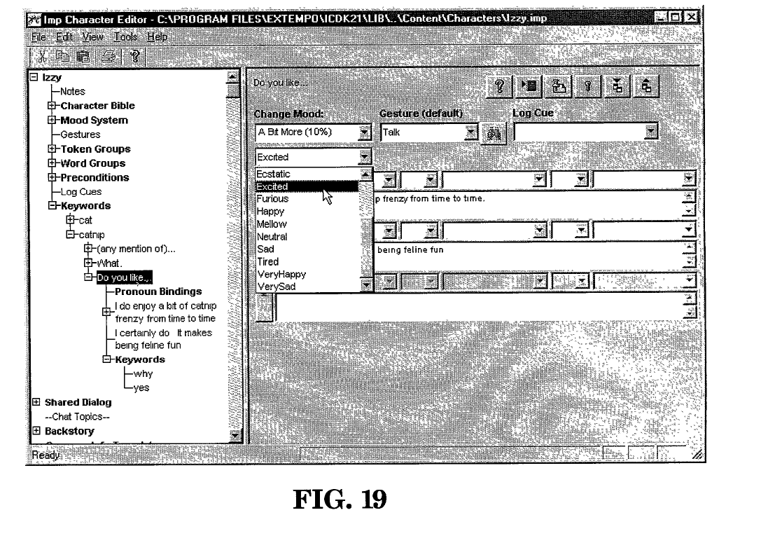

Use the Change Mood pull-down menus to alter your character's mood when it comes to this section of the dialog. Think about how this topic of conversation makes your character feel. If the topic is a fond one, it might make the character Slightly More Happy when it says the dialog. If the topic is sad, it might make the character A Lot More Depressed. Use your judgment. FIG. 19 illustrates a screen for entering how the agent's mood should change in the context of specific keywords input by the user.

It is not possible to have one line of dialog responding to a particular keyword pattern make the character Slightly More Happy and another under the same pattern make the character A Lot More Furious. Think about mood on a per-topic, not per-line, basis. No matter which line it picks to say, the topic should have the same effect.

Some lines of dialog, like those in the Backstory chat topic, have default Change Mood options. For example, Insults automatically make the character More Angry. You can adjust them if you so desire. You can also enter arbitrary percentages in the percentage box.

Use the Gesture pull-down menu to set a gesture that will be associated with every line of dialog in the Multiple Dialog screen. This menu is really a shortcut to assigning gestures, as you might not want to give every line under this particular keyword the same gesture. Use the Single Dialog screen(s) if you want to give each line of dialog a different gesture.

Select a Log Cue from this pulldown menu to apply it to all of the lines of dialog for this particular keyword-question stem combination. Again, this is a shortcut to assigning log cues, as sometimes you may want certain lines of dialog within the same dialog area to have a different log cue.

The first pull-down menu atop every line of dialog is the dialog's Action Type. It functions the same way as it does in the Single Dialog screen. The next two pull-down menus are the Use When Mood menus. They function the same way as they do in the Single Dialog screen. The last two pull-down menus are the Precondition menus. They function the same way as they do in the Single Dialog screen.

As token groups lend variability in keywords, word groups lend variability in dialog. Word groups can be included in lines of dialog as you are authoring. Then, entries in a word group can be selected at random at runtime so that your character never says the same line quite the same way. Word groups, like token groups, begin with the # character. Several word groups are built-in but must be filled in with words specific to your character.

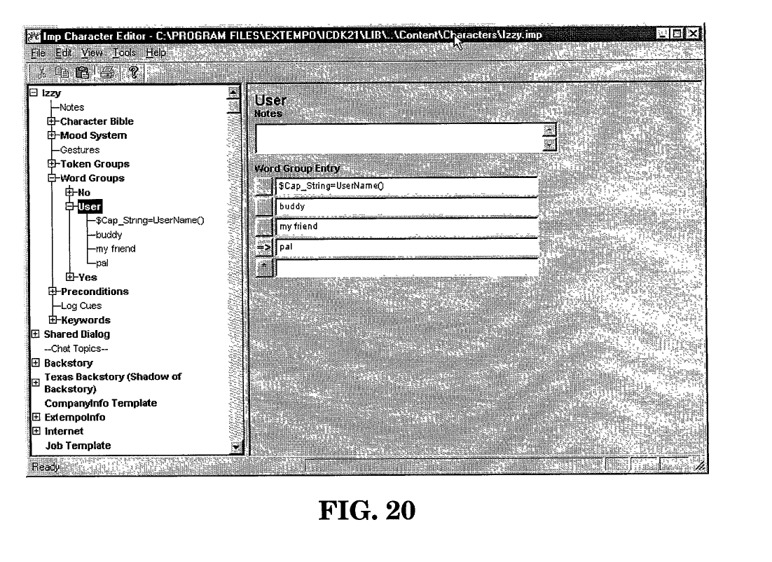

FIG. 20 illustrates how to make entries into a word group. One of the built-in word groups is #User, which stands for the ways the character names the user. Within the word group #User, one entry is built-in: $Cap_String=UserName( ), which stands for the user's actual name (if they had entered it at the beginning of the interaction when the software asked for it). In the blank box, you can begin entering specific words that the character can use to refer to the user, like “my friend,” “buddy,” “my pal,” etc. When you write the line of dialog “How are you, #User,” the character might say any of these lines at runtime: “How are you, Mike,” “How are you, my friend,” “How are you, buddy,” or “How are you, my pal?”

You can make as many word groups as you want and use them in dialog. For example, you might create a word group #Animals to make the sentence “I really like #Animals” different every time. Keep in mind, however, that your character will have no idea what animal the ImpEngine picked, so if the randomly selected animal produced the sentence “I really like camels,” and the user says, “I love camels!” if “camel” is not already a keyword the character will not comprehend.

Entries in word groups, like lines of dialog, each have options for Use When Mood, Precondition, Weight, Order, and Pronoun Binding. Use these in the same way you use them when authoring complete lines of dialog. Obviously, you do not want your character to call the user “my friend” if the user has just spent twenty minutes insulting the character; you would set Use When Mood to avoid this situation.

You may have noticed that there are many ways a dialog's properties may affect when it is used, some of which do not seem exclusive of each other. If the ImpEngine finds more than one line of dialog that is available to match a particular user utterance, the ImpEngine selects the final dialog according to the following algorithm. The ImpEngine looks at all of the possible dialog options, and passes them by a set of five criteria. The criteria themselves are:

Order

The ImpEngine looks at the order field associated with each piece of dialog and compares it with the order it wants (if it had previously said something in this set of dialog with Order=1, it will look for something with Order=2). If the order matches, the line of dialog meets this criterion.

Non-Repeating

The character keeps track of dialog entries it has used before. If the dialog entry has not been used before, the line of dialog meets this criterion.

Mood

The ImpEngine looks at the mood associated with the dialog and compares it to the mood of the character. If the character is in the mood, the line of dialog meets this criterion.

Preconditions

If any precondition is attached to the line of dialog, it is compared with the preconditions that may have been triggered during the interaction. If the precondition requirement matches, the line of dialog meets this criterion.

Closest Order

The ImpEngine looks at all of the available lines of dialog and determines which one has the largest Order value. If the desired order value is not available, it uses Closest Order to evaluate the dialog. For example, if the ImpEngine has already said something with Order=2 it would ordinarily look for Order=3, but say it sees that all the lines of dialog in a particular case are either Order=1 or Order=2. Since it determined that the largest Order value in this group of dialog is 2, it will designate lines with Order=2 as lines that meet the Closest Order criterion.

Using these criteria, the ImpEngine groups the available lines of dialog into seven sets. A line may not be included in a set unless it meets all of that set's criteria.

Set 1 contains lines that meet Order, Non-Repeating, Moods, and Preconditions

Set 2 contains lines that meet Order, Moods, and Preconditions

Set 3 contains lines that meet Closest Order, Non-Repeating, Moods, and Preconditions

Set 4 contains lines that meet Closest Order, Moods, and Preconditions

Set 5 contains lines that meet Non-Repeating, Moods, and Preconditions

Set 6 contains lines that meet Moods and Preconditions

Set 7 contains lines that meet Preconditions The sets are then searched in order (1 to 7), and the final dialog is chosen randomly from the first set that isn't empty.

Roles and Applications

A character is defined by its mood dimensions, moods, and backstory. When a character is ready to meet the public, a character should also play a Role. A role is a bundle of abilities designed for a specific task. By enabling a role for a character, you give the character access to that role's abilities, and can create Applications for the role. While moods or backstory are constantly available to the character, a character can easily change, add, or swap around its roles and applications, so you can easily develop multiple roles for the same character and produce different versions of the character for different sites or purposes.

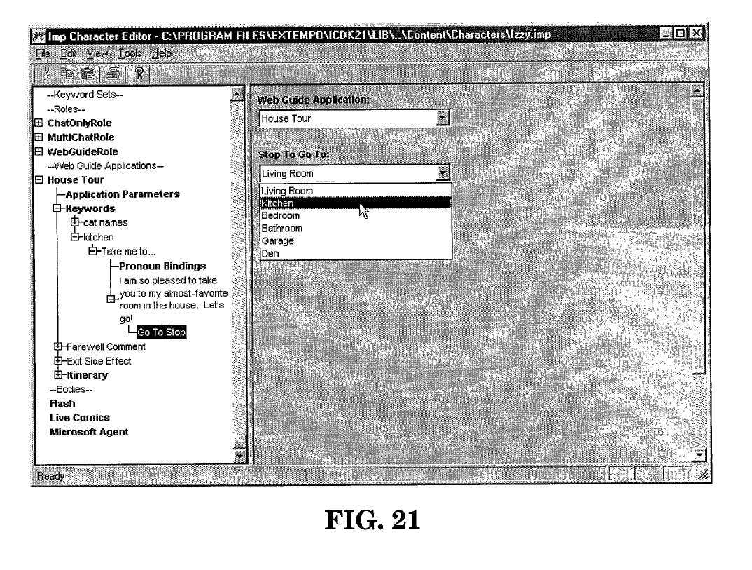

The Editor currently gives you access to three standard roles, shown in the left pane of FIG. 21. Each role contains a set of likely categories of user input your character will probably encounter while it is playing each role. The Chat Only Role is the default role that extends your character with new keywords and dialog. The Web Guide Role enables characters to act as website tour guides. The MultiChat Role enables a character to respond to questions but not carry on ongoing conversations. You can create your character in any role, but at least one role is necessary to run your character on a website. Other examples of roles include sales assistant, learning guide, customer service agent, messenger, survey administrator, website host, game opponent, and marketing agent.

By default, every new character is playing the Chat Only Role. This is the basic role that the other, more complex, roles are derived from. Characters playing the Chat Only Role can converse with users, but have no other specific tasks to perform. The Chat button on the Chat Only Role screen lets you test your character in this role after you configure it. The Retest button on the Chat Only Role screen lets you test your character without reconfiguring it (it will launch an interaction without taking into account any changes you made since the last time you configured it). Keywords in the Chat Only Role are just the same as in the Backstory Chat Topic or the other chat topics. You should author content here that only applies in this role and not in the others. If your character is hanging around the water cooler, for example, it might be willing to chat about things it wouldn't discuss while he was working.

Noncomps (short for “non-comprehended dialog”) are things the user says that the character doesn't understand. This means that it hasn't been able to match what the user said to any of its keywords or token groups. The Chat Only Role has a special section for writing the things the character will say in response when it registers a noncomp. Creating noncomp responses is just like creating ordinary dialog. You may provide a set of noncomps, each with its own conditions, including the moods for which it is appropriate, its weight or order in the list of noncomps, or its action type. Although noncomps function just like any other dialog, they have a special importance when you're designing your character. Since no character understands natural language perfectly, there will be many occasions on which the character has to respond to a user with a noncomp. To keep the character from sounding repetitive, it's important that you design a wide range of believable noncomps. A character that says only, “I don't understand” will quickly seem lifeless and unintelligent.

Your character should be deferential but not simpering when it doesn't understand. The character should ask the user to rephrase, not to repeat or say it louder. If the user repeats himself in the exact same words, the character still won't understand; “say it louder” is a cop-out since your character has no sense of hearing. The character should never blame the user for a noncomp (e.g. by suggesting that the user might have misspelled something) because most of the time, it actually is the character's “fault.” Noncomp responses such as “I didn't get that, could you rephrase?” or “I'm sorry that I'm not understanding you—could you say that differently?” are your best bet.

Notice that noncomps are a property of a particular role, so each role you build for a particular character will need its own noncomps. You can easily share them among roles by using Shared Dialog, of course. However, you may want to craft different noncomp responses for each chat topic so that a chatty character's noncomps may be friendly, for example, “Wow, I didn't understand that at all! Mind rephrasing?” while the same character in a working role may be more formal: “I don't believe that's something I am familiar with. Can you rephrase?”

Enter the ways the character will respond to the user saying goodbye. When the user says goodbye, the character will say a line of dialog from here and close the interaction.

The MultiChat Role is for carrying out noncontinuous interactions with many users. This means that every new utterance is treated as the “first” utterance, and receives a single utterance in return. Since there is no ongoing thread of interaction, a character in the MultiChat role will not have moods, cannot tell stories, and cannot remember the user from one utterance to another. The MultiChat role is most useful for simple FAQ-answering applications and not for applications where conversation continuity or user modeling is essential. The MultiChat role has two sections, Keywords and NonComps. These sections function the same way as in the other roles.

A character playing a Web Guide Role gives tours of websites, or can be adapted to perform a variety of proactive tasks. You can provide it with a Web Guide Application containing an itinerary of Web pages to visit, and it will go from page to page, presenting new dialog on each page, and answering questions about what it's showing to the user. For the web guide application to function correctly, you need to fill in the dialog in the Web Guide Role section, which is dialog for responding to a collection of inputs a character might encounter while it is giving a tour. This role is appropriate for web-based characters that need to move around on the web, such as teachers, advertisers, or tour guides.

This role is similar to the Chat Only Role, but has some additional content. It has predefined categories of dialog that might reasonably come up during a tour. For example, a user might comment on liking or disliking the tour, might ask to go back to a previous page, or might want to end the tour. By writing dialog for these existing categories you guarantee your character can handle the basic mechanics of being a web guide.

The role section does not contain the details of a specific tour. The role has the general behaviors your character will use on any tour it might give. Once you've authored the role, you then create a very specific Web Guide Application (see below), which specifies the itinerary and other details about that particular tour. Remember to keep your character's dialog in the Web Guide Role fairly general, since it might be used in many different tours.

Here are the categories of dialog in the Web Guide Role, along with a brief explanation of what each category is used for. In most cases there are more detailed lists of specific utterances within each category (so the Help category, for example, contains questions like “How long is the tour?”).

| Dialog | |
|---|---|
| Category | Description |
| Keywords | Just as in the Chat Only Role, you can add your own |
| | keywords and dialog in this section. It starts out |
| | empty |

Responses to User Questions

| | |
|---|---|
| Help | Help covers basic user questions, including “How long |
| | is the tour? ” “Where are we going? ” “What can you |
| | do? ” and a generic help response when we know the |
| | user is asking for assistance but can't narrow it down |
| | further. |
| Application | Replies to user comments about liking or disliking the |
| Feedback | tour. |
| Other | Replies to greetings and navigational requests. Notice |
| | that the “Let's go back” request actually moves the tour |
| | back to the previous stop (see Action Types below). |

Web Guide Comments

| | |
|---|---|
| Stop | This category contains the character's dialog for |
| Navigation | moving from stop to stop in the tour. This is where it |
| | asks “Are you ready to move on? ” tells you “This is the |
| | last stop,” and so forth. Notice that the “Are you ready |
| | to move on? ” question actually does move the tour to |
| | the next stop if the user answers “yes” (see Action |
| | Types below) |
| NonComps | Various utterances used when the character doesn't |
| | understand what the user has typed (discussed above). |
| Sleeping & | Dialog the character speaks when it goes into sleep |
| User Inactivity | mode or wakes up during a tour. You set the values for |
| | how patient or sleepy the guide is when you create a |
| | specific Web Guide Application (see below); all you do |
| | here is provide the dialog it will use. |

As you will remember from above, each piece of dialog in the Editor has an associated action type, such as Fact or Question w/Followup. Characters that use the Web Guide Role can make use of several new action types in their dialog in addition to the basic set. They are:

Email

This action type allows the character to electronically mail a message to the user. You should have two kinds of dialog for every time you want to send email: one that has a precondition KnowUserEmail, and another that has the precondition Not KnowUserEmail. Both lines will have the Action Type of Email.

In the KnowUserEmail case, your line of dialog should say that the character is going to send some email, whereupon the character will automatically send the email and say the Sent Email Response (usually something like, “I hope you enjoy it!”). In the Not KnowUserEmail case, the line of dialog should ask for the user's email address. If the ImpEngine recognizes the immediate answer as an email address, the character will automatically send the email and say the Sent Email Response.

Ideally, you should ask the user's permission before sending them email by setting up a system of dialog with preconditions. The first line of dialog, a Yes/No Question, should ask for permission to send a message; two different Yes answers, with action type Email, should proceed as above, while the No answer should apologize for the intrusion (many people today are wary about computers “collecting” their email addresses).

The message sent contains the contents of a text file, which must be created and its location specified in advance. The file should be placed on the character's server in that location. So that the ImpEngine can send the text file as an email, the text file should contain: one line with the character's email address, the next line for the subject of the email, followed by the message content. Here is a sample:

izzy@extempo.com

Subject: My favorite cat names

Here are a few of my favorite names:

Dizzy

Ezri

Fuzzy

And naturally, Izzy!

Hope these help.

Izzy Of course, use your character's “real” email address (and make sure that address exists at your company in case people reply!) and give a relevant subject line.

Sleep

This action puts the character to sleep; it will passively wait for input from the user before waking up. While asleep it will not speak or act. This is useful when you expect the user to take some time looking at a Web page, and don't want your character to keep prompting the user to move on.

Go To Stop

FIG. 21 illustrates a screen for selecting a particular stop on the tour. With this action your character will go to a particular stop on the tour that you specify. This function enables your character to jump from stop to stop without having to follow the itinerary. If, for example, Izzy were giving a tour of his house and the user said “Take me to the kitchen,” Izzy could go to the kitchen page directly. When you select the Action Type Go To Stop, a new entry in the tree appears, entitled Go To Stop. Selecting it reveals the screen where you select which stop the character should go to.

Return

Return takes the user back to the previous stop on the tour itinerary, and continue where it left off on that stop's agenda. When this action type is used, the character goes back to the previous stop, but cannot do so to backtrack through an entire tour—the character always takes the user back to the immediately “previous” stop. If you went from A to B to C, then triggered a Return while on stop C, the character would go to stop B. If you subsequently triggered another Return, the character would “return” to stop C because that was its most “recent” stop.

Goto Next Stop

This moves forward to the next stop on the tour itinerary.

Say Bye and Exit

This action stops the tour and shuts the character down. There will be no further actions after this one, so make certain that the character says goodbye and makes it clear that the tour is over.

These action types should only be used within the Web Guide Role. Nothing about the Editor prevents you from using them in the other topics, but they won't work if your character isn't performing a web guide application when they come up.

Use these action types if you want to break out of the linearity of the itinerary. The web guide itinerary itself handles all the basic tour navigation for moving forward from stop to stop, moving back at user request, and ending the tour; you just create specific utterances for the existing dialog categories. Use these action types if you want more fine-grained control in response to specific user commands.

The Web Guide role broadly describes how a character behaves when it is giving a tour—any tour, be it an astronomy site, movie reviews, or a pet shop. The Web Guide Application contains the tour itself. The web guide application defines the stops on the tour, the keywords the character knows about while it is giving that particular tour, how fast the tour moves, and so on. You may have many web guide applications in a single character, but the character can only use one application at a time, so it's best to split up applications amongst different copies of the Imp Character (see details below).

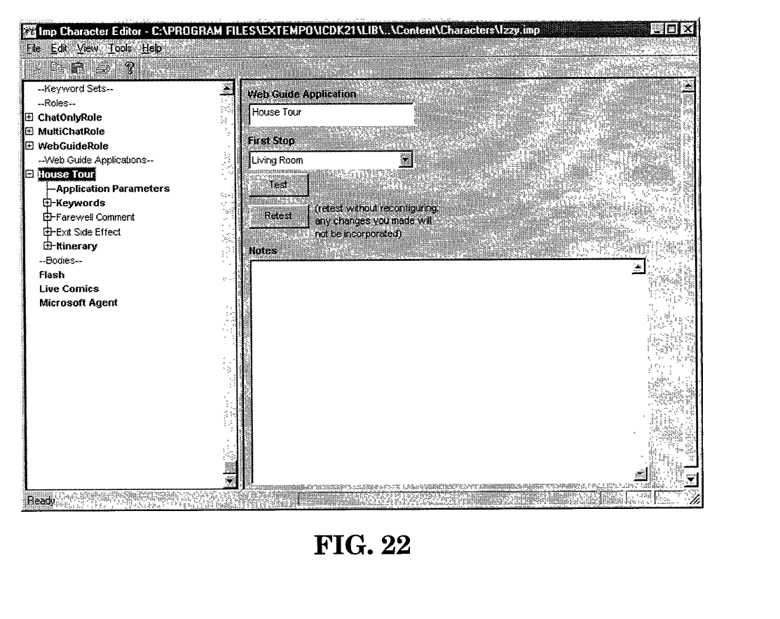

FIG. 22 illustrates creating a new Web Guide Application. To describe the details of a particular tour (of an astronomy site, say), you create a Web Guide Application by clicking on the Web Guide Role heading and clicking on the New Web Guide Application button on the right side of the Character Editor, or you can select that option from the File menu. When the dialog box appears, name your web guide application something descriptive. You can also import an existing web guide application from another character by clicking the Import Web Guide Application button on the Web Guide Role screen (useful if you want two characters to give roughly the same tour). When you create a Web Guide Application, you see the following options:

The names of all authored stops are listed in the First Stop menu. Select one of them to make it the default First Stop, which is the stop where the tour “begins.” If you configure the character to use this Web Guide Application, clicking Test will let you test it.

Expanding the Web Guide App heading reveals some new headings. Here is a description of those fields.

The Application Parameters of a Web Guide Application control the flow of the interaction—how quickly it moves and how patient the character is on each page. You are free to change these values. The Application Parameters are as follows:

| Parameter | Default | Description |
|---|---|---|
| Ask If Ready | 60 | At the end of a stop, the character asks a user if |
| Repeat Time | | he/she is ready to move If the user does not reply |
| | | or answers “no,” this is how many seconds |
| | | the character will wait before asking again. |
| Fidget | 10 | How many seconds the character will wait for the |
| Interval | | user to respond to a direct question before it |
| | | will begin to idle. |
| Initiation | 5 | The time in seconds the Web Guide must be idle |
| Patience | | before performing the next step in the current |
| | | stop's agenda. |
| Patience | 90 | How many seconds the Web Guide will wait for |
| | | the user to respond to a direct question before |
| | | giving up and falling asleep. |
| Speed | 10 | The time in seconds the Web Guide will wait |
| | | before going on to the next item on the current |
| | | stop's agenda. |
| URL Load | 5 | The time in seconds the Web Guide will wait |
| Delay | | after directing the browser to a new URL before |
| | | beginning the agenda for the stop. |

Authoring application parameters takes some practice. It's difficult to tell in advance how long you want your character to wait, or how fidgety you want it to be. Often it's simply necessary to run through the tour to adjust these values until they “feel” right.

Keywords function the same here as they do in the other sections. Keywords entered in the Web Guide application will only be active when the Web Guide application is active.

Farewell Comments are dialog your character speaks when the tour is ending. It can be “So long, come back again soon!” or any other dialog.

The Exit Side Effect dialog occurs when the session ends. The character will generate the dialog, but not actually speak it. You might want to use this slot to set a variable, access an external data source, or perform any other tasks that need to be performed when the session ends.

The Itinerary is the heart of a Web Guide Application. This is where you spell out where the character will take the user and how its actions and knowledge should differ from page to page. An itinerary consists of a group of Stops, usually web pages. Each stop has an Agenda of one or more Steps of dialog the character says. It goes through the agenda in order, saying something for each Step before moving on to the next Stop.

There are a variety of ways you can put content into the Web Guide Application. You can simply divide your application into logical sections, which will become stops in the Web Guide itinerary, or you can make divisions based on points when you want your Imp Character to display a different Web page, creating a new stop for each Web page.

Begin by clicking in the Stop Name field where it says First Stop. Replace First Stop with a descriptive name of the first stop of your application. Fill in the names of the other stops in your application. The program will automatically number your entries and bring up additional lines as necessary.

You use the Next Stop fields to tell your Imp Character which stop follows which. In the Next Stop field to the right of your first stop name, use the pull-down menu to select the name of the stop you want to follow your first stop, unless, of course, you don't want the character to automatically move onto the next stop. Designate next stops for all stops, as appropriate. By default, once a tour has begun, the tour guide character will go through the stops in order, as long as you make sure to always specify a Next Stop. At each stop it will go through the agenda steps in order. The properties of a stop are:

Stop

When you create a stop, you give it a name, a URL (the Web address you want the character to visit, if any), and the name of the stop to go to when this one is completed. You may also turn certain prompting questions (such as “Are you ready to go on?”) on or off at each stop. Here are the descriptions of those questions.

Can the User say “Next” to move to the next page?

If this box is checked, the user may say “Next” to move to the next page and not wait for the character to prompt him.

Override the default “Let's Go On ” comment when User says Next?

If this box is checked, the Editor will provide you with another heading under this Stop where you can enter special dialog for this stop's “Let's Go On” comment. For example, you might want to make a specific stop have a specific “Let's go on” comment, like “This next page has some great pictures of Mars. Let's go check them out.”

Should the character ask the “Ready to Move On” Question at the end of the Agenda?

If this box is checked, the character will ask the user if they are ready to move on before going to the next page. If this box is not checked, the tour will stop short at the end of this stop's agenda and will not continue anywhere else, even if the user says “Next.”

Override the default “Ready to Move On” Question?

If this box is checked, the Editor will provide you with another heading under this Stop where you can enter special dialog for this stop's “Ready to Move On” question. For example, you might want to make a specific stop have a specific “next page” question, like “This next page has some great pictures of Mars. Wanna check 'em out?”

Test

Click this button to test your character beginning at this stop. Using this function lets you test individual stops instead of wading through an entire complicated itinerary each time you want to check something.

Keywords

These are keywords specific to this stop only. Be sure to create dialog for your application's “Farewell Comment,” which can be found under your Web Guide application name label, and for any built-in NLU for the Web Guide Role that you want your character to respond to.

Stop Overview

This is a collection of possible user inputs that the character should respond to in a specific way for every stop.

Stop Agenda

Click on this button to add steps to the Stop Agenda. New Step entries will appear in the tree. Step items can include pieces of dialog and action types. Click on the entries to begin adding dialog. Authoring dialog for a Step is just like authoring dialog for ordinary keywords. Click on the Step 0 label to bring up the Step 0 dialog screen where you can enter dialog.

You may control the order in which steps are visited or the delay between individual steps by clicking on the main Stop Agenda heading. If you want your character to move automatically to the next stop, it's a good idea to include a blank agenda item with the action type GoTo Next Stop (WebGuide). This tells the character to move on to the stop you designated as next. Adding a blank stop permits you to control the timing of the character more precisely than if you simply make the last piece of dialog in a stop into a GoTo Next Stop (WebGuide) action type.

When you configure a character in a particular role, you can test the character's interaction in that role from within the Editor. Once your dialog has all been entered into your Web Guide application, you will want to test the application so you can adjust the timing and correct any mistakes. After configuring for the Web Guide Role, you can test the application by clicking on the name label for your Web Guide application and pressing the Test button. Make adjustments to the application parameters and stop agenda screens as appropriate.

To test a character in the Chat Only Role, configure it first. Then go to the heading Chat Only Role and click the Test button in the work pane. A console window will compile the character for launch and then a chat window will appear, with your character and yourself (“guest”) as participants. You can interact with the character here by typing into the text box. Your character behaves here the same way it will function on a website, except its behavior with regards to timing is not precisely the same, it will always perceive you as a new (not return) visitor, and some preconditions may not function since there may not be an available database to store them.

To test a character that has a Web Guide Application, configure it first. Then go to the heading Web Guide Application (not the Web Guide Role heading) for the particular application that you wish to test and click Test in the work pane. The same generic chat window will appear and the character will begin its agenda.

The Web Guide Role is adaptable to purposes other than leading tours of pages on websites. You can use the Web Guide Role to make your chatty character proactive, that is to say, they will be able to actively bring up topics for conversation instead of passively sitting around waiting for the user to say something that matches their keywords (as it would in the plain Chat Only role).

You can accomplish this by creating an itinerary containing one stop that doesn't include a URLs, but whose steps contain topics of conversation you want the character to progress through. For example, Step 1 could be “What's your name?” Step 2 could be “What's your favorite color?” and Step 3 could be “Do you like Monty Python movies?” The character will try to move to all of these steps, that is to say, to ask these questions during the interaction, but will also allow itself to get sidetracked if the user engages it in conversation. Add enough steps to keep things fresh. The last “step” on the agenda could cycle through random topics of conversation endlessly until the user got bored and left. (Shared dialog from Backstory is extremely well-suited to this purpose.)

The basic Imp file for a character should be called CharacterName.IMP (for example, Merlin.Imp). This basic file, called the persona, includes the character's mood system, backstory, token groups, word groups, shared dialog, preconditions, and any keyword sets you might want to share.

When naming the web guide application, you don't need to include the character's name in the name of the application. Try to be specific about the name, so that reading the name of the application will be enough to know exactly what the application is for, i.e. ExtempoTour, ChatterBot, FinanceDemo.

When you create a new web guide application, you should create a new copy of the Imp file that includes the name of the character and the name of the application in the style CharacterName_ApplicationName.IMP. For example, Merlin might have three applications, and so there should be three extra IMP files: Merlin_ExtempoTour.IMP, Merlin_ChatterBot.IMP, and Merlin_FinanceDemo.IMP. Do your work on each web guide application in the appropriate Imp file, but do your work on global content (like Backstory) and global properties (like the mood system) in the basic Merlin.IMP file. Then, use Update Character to copy your changes from the Persona file to the three Application files.

There are several advantages to splitting the character's applications up in this way.

1. It keeps a “clean” version of the character that can be used as a starting point for new applications.

2. It keeps the content for different applications separate.

3. It allows content development on the character's Persona and various applications to proceed in parallel, even with different writers working on the various pieces. The application-specific files can be updated with any changes in the Persona using the Update . . . function in the Editor.

4. It allows you to update basic content in the main Persona file, then update it to each of the application files instead of requiring you to author it four times.

Physical Representations

Physical representations of your character make it come alive. The Bodies section of the Editor contains the mechanisms for configuring art to function with your character. Presently, there are two different “bodies” that a character can have: LiveComics and Microsoft Agent. New body types may be added in the future, using Flash, Pulse, or other technologies. Extempo's authoring software allows you to use the same content for any body type.

LiveComics is a Java-based client that uses two-dimensional .JPEG and .GIF images of the character in conjunction with a text box or balloon. It functions much like a text-only chat room where the participants are your character and one user.

Microsoft Agent is the three-dimensional character client that allows the character to drift above all windows, which seems to give it more presence and power. This client allows the character to speak aloud.

Flash is a streaming animation technology that Extempo technology can now interface with. Users must download the Flash plugin to see a Flash character.

Inductive Authoring

Inductive Authoring is a way of checking a single word or a word in a keyword pattern you are writing against the built-in token groups. Recall that token groups are groups of related words that are useful for expanding keywords to cover more possible input. It is entirely possible that while you are writing a keyword, you might not know that a word you entered is part of a larger token group. Replacing the word with its token group would increase your keyword coverage.

For example, inductively authoring the keyword I want a cat might result in the new keyword #I #want a #cat. This would allow the character to respond to a greater range of inputs, like “I need a cat” or “me want a kitty,” that all mean the same thing. Inductive Authoring also allows you to examine the words that are built into predefined or new token groups.

In order for Inductive Authoring to function, a character's knowledge must have been configured on the local machine at least once. If the character has been configured before, you may load the knowledge directly by selecting Inductive Authoring Properties from the Tools menu and clicking the Load Knowledge button. It is a good idea to reconfigure the knowledge whenever new token groups are added so that they get integrated into Inductive Authoring. Knowledge that has been loaded into Inductive Authoring is reset whenever a different character is loaded into the ICE.

Once the appropriate knowledge has been loaded and Inductive Authoring has been enabled, Inductive Authoring may be used to generalize any keywords or examine any token group. In the work pane, go to the keyword you wish to process and go to the View menu. You will see two Inductive Authoring options in the menu. Selecting Inductive Authoring: View Alternative Patterns . . . from this menu will process the keyword. If any parts of the

keyword can be replaced with token groups, a dialog box will appear with alternative selections for keywords. If the keyword or highlighted text consists of a single, existing token group like #cat, you may use Inductive Authoring to Display Token Group Entries. This is useful for uncovering the contents of built-in token groups, or reminding yourself what you authored into new ones.

The advantage to Inductive Authoring is that you can simply write your keywords as they make sense to you, then run them through Inductive Authoring to optimize them for user utterances you might not have anticipated. Inductive Authoring works best for expanding the coverage of phrases, rather than standalone, single-word keywords. Typically, one-word keywords are very specific to particular situations and should not be generalized.

Storing User Responses

The Imp Character Editor uses a number of commands that can capture what a user says and remember this information across repeat visits by storing the data in a database. In addition, the character can repeat back what he or she knows about the user. This is accomplished through Expressions that can be used in keywords and dialog. Here are two relevant expressions to this task.

For capturing data, use this expression in a keyword

$StringAttribute(variable_name)<#tokenGroup

For reading back data, use this expression in dialog

$String=UserAttribute(“variable_name”)

When you use this feature, you specify a variable name that denotes the captured data. The variable name needs to be one word with no spaces, although some special characters like “_” are allowed. The variable should be descriptive. For instance, if you use the code to remember where the user lives, you may decide to call your variable User_Hometown.

To store data, insert the “capture” Expression into a keyword. As an illustration, consider how the keyword pattern I #reside in could be modified to remember where the user lives. Before using code, if a user were to say “I live in Omaha,” the first three words would match the keyword pattern, and the character might respond “I hear that's a beautiful place to live!” As you can see, the character merely makes this pithy generic remark because it doesn't truly understand that Omaha is a city.

Now consider if the keyword were changed to I #reside in #AmericanCities. The token group makes the keyword more specific. The user can say “I live in Omaha” (assuming Omaha is in the token group #AmericanCities) and the character would understand that it is in fact an American city.

Now that a token group has been added to the keyword pattern, the data capture code can be inserted. This would make the keyword

I #reside in $StringAttribute(User_Hometown)<-#AmericanCities (The <- notation stands for an arrow.) The token group #AmericanCities “points” to the variable User_Hometown, meaning that for something to be stored as User_Hometown, it must be found in #AmericanCities, or the keyword won't match. Thus, if a user were to say “I live in Omaha,” the keyword would not only recognize this pattern, but also store “Omaha” in the variable User_Hometown. This data can then be permanently saved in a database or used in dialog.

Using a token group to specify what kind of data should be saved is a necessary step. However, there are a number of instances where an author may need to capture some data that has no associated token group. For example, you may want to remember the user's last name, but clearly there is no token group that contains every possible surname in the world. To do this, you must use a special class of token groups. This class consists of:

#miscAnyOneWord

#miscAnyTwoWords

#miscAnyNumberOfWords

These token groups “contain” any and all words. Thus, to remember somebody's last name, you could author a keyword like

last name is $StringAttribute(LastName)<-#miscAnyOneWord This would match “My last name is Smith”, “My family's last name is Wong”, and more. Whatever one word comes after “is” in the keyword will be caught by #miscAnyOneWord, and will then be saved in LastName. Of course, tricky users can defeat the purpose by saying “My last name is Idiot,” so you may want to think twice about having your character later speak what it has stored in #miscAnyOneWord. The important thing is to store the data, not show off its ability to parrot the data back.

Make sure your keywords are designed well enough that the #miscAnyOneWord will not catch extraneous information. Consider the above example of remembering the user's hometown. By replacing the token group #AmericanCities with #miscAnyOneWord, the character will not be limited in the kind of responses it can catch. The new keyword would look like this:

I #reside in $StringAttribute(User—Hometown)<-#miscAnyOneWord

However, this can cause some problems. If a user were to say “I live in Los Angeles”, only the word “Los” would be saved. One solution to this is to make several keywords of differing importances: one that remembers one-word answers and another that remembers two-word answers (the two-word pattern should be more important than the one word pattern). The best way to find out what patterns work best is through trial-and-error. Therefore, it's always best to test your character a number of times to see how it responds in real-world scenarios.

When a character remembers a piece of data, it is automatically stored in a “User Profile” database. As an author, you can “peek” into this database and repeat back some of the information the character has learned. This is done with the UserAttribute command. Suppose you wrote a keyword that remembers where a user lives. Such a keyword could look like:

I #reside in . . . $StringAttribute(User_Hometown)<-#AmericanCities

If the user response matches the keyword as above, the hometown will be saved as the variable User_Hometown. To have the character repeat this information, a followup response could be written as:

Character: I've heard good things about

$String=UserAttribute(“User_Hometown”).

(Note that the variable is enclosed in quotation marks as well as in parentheses. This is a requirement of the UserAttribute command.)

The UserAttribute command simply looks for the specified variable in the database, and inserts the value that it is associated with into the dialog. If there is no value associated with the variable, there will simply be a blank space in the dialog, which would look like this: “I've heard good things about .” For this reason, use preconditions to track whether your character has learned where the user lives (or anything else your character might need to know) before you have it try to say lines that include stored user information. If the character hasn't learned the information, it should offer a different line of dialog.

It should be apparent from the above description that a wide variety of potential contexts are within the scope of the invention. Potential contexts include any type of user input during operation of the agent, internal events or states of the agent, and input from a different computer-controlled process. A user input may communicate a message or user gesture (e.g., hand gesture, body language, or facial expression such as smile, frown, or scowl), and may include typed or spoken words, menu selections, or selection of items on a display. A communicated message can effect a social transaction such as a greeting, farewell, insult, praise, flattery, flirtation, aggression, admiration, beckoning, affirmation or rejection; a question instantiating a form such as what, when, why, where, how, do you like, or do you dislike; a request for help such as “Where am I?”, “Where are you?”, “What can I do here?”, “What can you do?”, “How can you help me?”, “What can I ask you?”, or “What can I say to you?”; or a comment instantiating a form such as I like, I don't like, you like, you don't like. A communicated message can refer to biographical information of the agent or user such as name, age, mother, father, sisters, brothers, siblings, birthplace, job, hobbies, interests, preferences, birthday, sexual orientation, romantic status, marital status, email address, home address, friends, pets, or cleaning habits; a mood of the agent; a mood of the user; a chat topic; a behavior of the agent; a previously-made comment or message from the agent; a previous action between the user agent, either in an ongoing operation or a previous operation of the agent; a Web site; a visual, textual, or auditory display; or an application such as a search engine, e-commerce system, registration process or simulation. The communicated message can include a request for operation of an application or display or navigation assistance. Messages from the agent to the user may have similar content as described above for messages from the user to the agent.

Internal events of the agent that are part of a potential context include a change (increase or decrease) in the agent's mood or user's assumed mood by a specified qualitative magnitude (e.g., slightly, somewhat, more, much more, or completely) along an underlying mood dimension such as well-being, energy, arousal, extroversion, and introversion; performance, initiation, or completion of a speech act such as a comment, question, answer, or story by the agent; delivery of a message by the agent, including messages about previous user input or agent capability; initiation, performance, or completion of an action by the agent, such as display of an animation of the agent, operation of a browser or other application, or presentation of a menu or display; and an itinerary of the agent. In the case of an itinerary, the internal event can refer to one of the stops, interactions at the stop, an agenda of the stop, a step of the agenda, or an action of the step such as communication, gesturing, changing mood, writing to a database, sending a browser command, running an application, or setting a precondition.

Internal states of the agent include moods of the agent or assumed moods of the user; or may refer to a message from the agent; an action of the agent, such as display of an animation of the agent, operation of a browser or other application, or presentation of a display or menu; or a itinerary of the agent. The state may signify that the agent is about to send or has just sent a message, or that the agent is about the perform or has just performed an action. The internal state can refer to arrival at or completion of a stop on the itinerary, interactions related to a particular stop, an agenda of the stop, interactions related to a step of the agenda, or actions of the agenda.

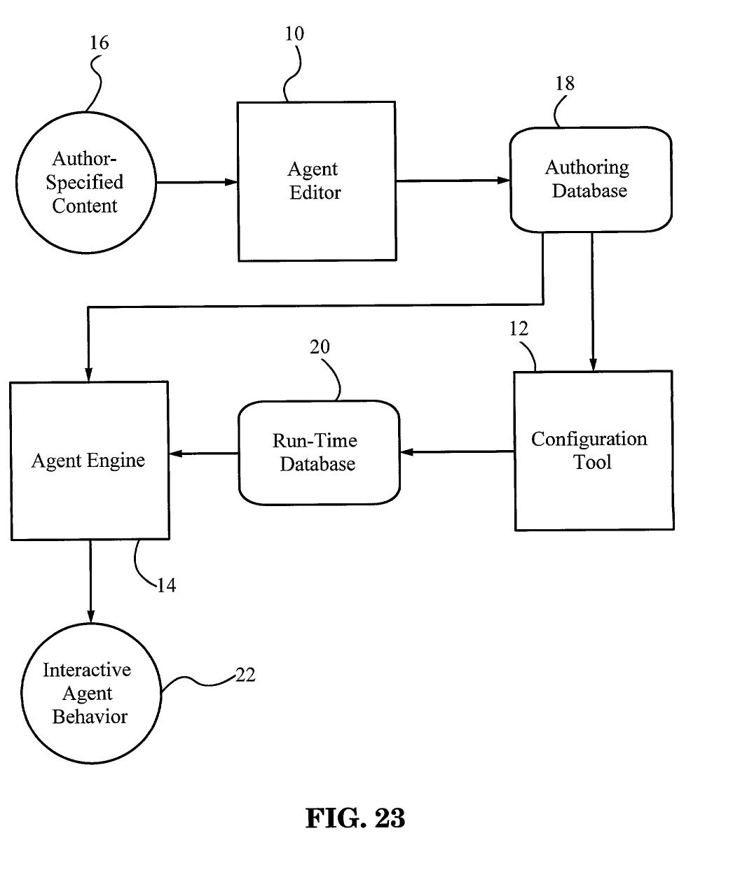

The agent editor described above is best implemented in the context of a run-time system. FIG. 23 is a block diagram showing interaction among three units that are used together to author interactive agents and to generate run-time agent behavior. These three units are an agent editor 10, an example of which is described in detail above; a configuration tool 12; and an agent engine 14. Agent editor 10 is a graphical user interface by which an author specifies the content 16 of a particular agent. The entered content is stored in an authoring database 18, which is processed by configuration tool 12 to be in a format suitable to be used by agent engine 14, shown in FIG. 23 as a run-time database 20. Authoring database 18 in which entered content 16 is stored may also be accessible by agent engine 14 without being processed by configuration tool 12. Agent engine 14 then uses either authoring database 18 or run-time database 20 to generate interactive agent behavior 22. One example of agent engine 14 is the Extempo ImpEngine, described in U.S. Pat. No. 6,031,549, issued to the present inventor, and herein incorporated by reference.

Content 16 is indexed in database 18 or 20 by the values of the state variables defining the context to which the content applies. Agent engine 14 retrieves content based on current values of the state variables and uses the retrieved content to control agent behavior 22. As described above, state variables include the behavior of the user; the agent's run-time state, including current values of moods or preconditions; patterns in the agent's authored content, such as contingent responses to a yes/no question; the passage of time, for example to trigger the next behavior in a story or the next item on an agenda; or the behavior of an external application, such as a reply to a database query or an internet search. Behaviors may include dialogue, gestures, movement, transfer to a different location within a behavior script, changes in the values of preconditions or moods, sending an input to other applications, and sending of email or other network message.

It will be apparent to one of average skill in the art how to implement the agent editor using standard or custom-designed database software and graphical user interface development tools, based on the above description. The agent editor may be implemented on a wide variety of computer systems including distributed computer systems in which the different units of a run-time system are implemented on different computers. A typical computer system includes a central processing unit, data bus, ROM, and RAM. The system also includes I/O devices such as a visual display, a keyboard, a pointing device, and a microphone. The agent editor is typically stored as computer instruction code in the RAM or ROM for execution by the processor. The particular type of code will typically depend on the specific processor used, although the code may be machine-independent code that is executed by a virtual machine running on the processor.

It will be clear to one skilled in the art that the above embodiment may be altered in many ways without departing from the scope of the invention. Accordingly, the scope of the invention should be determined by the following claims and their legal equivalents.

What is claimed is:

1. A method for authoring content of a computer-controlled agent, said method comprising the steps of:
a) identifying a potential context of said agent for an author;
b) receiving a content for said agent in said potential context from said author; and
c) storing said content such that said content can be accessed by a run-time system that uses said content to control a behavior of said agent in an actual context, which occurs during an operation of said agent, wherein said actual context matches said potential context.

2. The method of claim 1, wherein said potential context comprises an input from a user during an operation of said agent.

3. The method of claim 2, wherein said input communicates a message.

4. The method of claim 3, wherein said message effects a social transaction.

5. The method of claim 3, wherein said message is a question.

6. The method of claim 3, wherein said message represents a request for help.

7. The method of claim 3, wherein said message is a comment.

8. The method of claim 3, wherein said message refers to an item selected from the group consisting of biographical information of said agent, biographical information of said user, a chat topic, a behavior of said agent, a received-message received from said agent, a Web site, a display, and an interaction between said user and said agent.

9. The method of claim 3, wherein said message refers to a mood of said agent.

10. The method of claim 9, wherein said mood comprises at least one of an emotion, a manner, an attitude, a style, and a feeling.

11. The method of claim 3, wherein said message communicates a mood of said user.

12. The method of claim 11, wherein said mood comprises at least one of an emotion, a manner, an attitude, a style, and a feeling.

13. The method of claim 3, wherein said message refers to an application.

14. The method of claim 13, wherein said application is selected from the group consisting of: a search engine, an e-commerce system, a registration process, and a simulation.

15. The method of claim 2, wherein said input communicates a gesture by said user.

16. The method of claim 2, wherein said input comprises at least one of typed words and spoken words.

17. The method of claim 2, wherein said input comprises a selection from a menu.

18. The method of claim 2, wherein said input comprises a selection of an item on a display.

19. The method of claim 1, wherein said potential context comprises an internal event of said agent.

20. The method of claim 19, wherein said internal event represents a change in an agent-mood of said agent.

21. The method of claim 20, wherein said change is of a specified magnitude.

22. The method of claim 20, wherein said change represents a change along a plurality of underlying mood dimensions.

23. The method of claim 19, wherein said internal event represents a change in an assumed user-mood of a user.

24. The method of claim 19, wherein said internal event refers to a performance of a speech act by said agent.

25. The method of claim 19, wherein said internal event refers to a message from said agent.

26. The method of claim 25, wherein said message refers to an item selected from the group consisting of a social transaction, biographical information of said agent, biographical information of a user, an agent-mood of said agent, an assumed user-mood of said user, a chat topic, a Web site, an application, an interaction between said agent and said user, an input of said user, and a capability of said agent.

27. The method of claim 19, wherein said internal event refers to an action of said agent.

28. The method of claim 27, wherein said action is selected from the group consisting of a display of an animation of said agent, an operation of a browser, an operation of an application, a presentation of a menu, and a presentation of a display.

29. The method of claim 19, wherein said internal event refers to an itinerary of said agent.

30. The method of claim 29, wherein said itinerary comprises a plurality of stops and said event refers to a particular stop from among said stops.

31. The method of claim 30, wherein said particular stop comprises an agenda and said event refers to said agenda.

32. The method of claim 31, wherein said agenda comprises a plurality of steps and said event refers to a particular step from among said steps.

33. The method of claim 32, wherein said particular step comprises a plurality of actions and said event refers to a particular action from among said comprised actions.

34. The method of claim 33, wherein said particular action is of a type selected from the group consisting of speech act, gesture, change mood, write to database, send browser command, run application, and set precondition.

35. The method of claim 1, wherein said potential context comprises an internal state of said agent.

36. The method of claim 35, wherein said internal state represents an agent-mood of said agent.

37. The method of claim 35, wherein said internal state represents an assumed user-mood of a user.

38. The method of claim 35, wherein said internal state represents a volume defined by a plurality of intervals on a corresponding plurality of underlying mood dimensions.

39. The method of claim 35, wherein said internal state refers to a message from said agent.

40. The method of claim 35, wherein said internal state refers to an action of said agent.

41. The method of claim 40, wherein said action is a selected from the group consisting of display of an animation of said agent, an operation of a browser, an operation of an application, a presentation of a menu, and a presentation of a display.

42. The method of claim 35, wherein said internal state refers to an itinerary of said agent.

43. The method of claim 1, wherein said potential context includes a plurality of elements.

44. The method of claim 43, wherein said plurality of elements includes a context element pre-defined for said author.

45. The method of claim 43, wherein said plurality of elements includes a context element defined by said author.

46. The method of claim 43, wherein said plurality of elements includes a context element predefined for said author and a second context element defined by said author.

47. The method of claim 1, wherein said potential context is identified for said author in a graphical interface.

48. The method of claim 47, wherein said graphical interface provides a labeled slot allowing said author to author said content by filling said slot with text.

49. The method of claim 47, wherein said graphical interface provides a menu of items allowing said author to author said content by selecting one of said items from said menu.

50. The method of claim 47, wherein said graphical interface provides a gesture table of gesture contexts, allowing said author to specify a particular gesture context in which a particular gesture can be performed by identifying a location in said gesture table.

51. The method of claim 50, wherein said gesture table includes a dimension representing a plurality of moods.

52. The method of claim 47, wherein said graphical interface provides an icon representing a function, allowing said author to author said content by selecting said function.

53. The method of claim 52, wherein said function specifies an interaction with an external system.

54. The method of claim 53, wherein said external system is selected from the group consisting of a browser, a database, and an application.

55. The method of claim 1, wherein said content enables said agent to deliver dialogue during an operation of said agent.

56. The method of claim 55, wherein said dialogue is authored explicitly by said author.

57. The method of claim 55, wherein said dialogue includes a variable, which may be replaced by a value selected from a specified group of alternative values.

58. The method of claim 55, wherein said content includes a specification of a manner of timing of said dialogue.

59. The method of claim 55, wherein said content includes a specification of a condition under which said dialogue is delivered.

60. The method of claim 55, wherein said content enables said agent to tell a story.

61. The method of claim 55, wherein said content enables said agent to ask a question of a user.

62. The method of claim 61, wherein said content enables said agent to deliver different dialogue depending upon said user's response to said question.

63. The method of claim 55, wherein said content enables said agent to choose among a plurality of alternative dialogue options.

64. The method of claim 1, wherein said content enables said agent to perform a gesture during an operation of said agent.

65. The method of claim 1, wherein said content enables said agent to change a mood during an operation of said agent.

66. The method of claim 1, wherein said content enables said agent to change a value of a precondition during an operation of said agent.

67. The method of claim 1, wherein said content enables said agent to interact with an external system during an operation of said agent.

68. The method of claim 1, wherein said content enables said agent to follow an itinerary, comprising a sequence of stops.

69. The method of claim 68, wherein said sequence of stops is influenced by an interaction with a user during an operation of said agent, as specified by said author.

70. The method of claim 68, wherein said sequence of stops is specified by said author.

71. The method of claim 68, wherein said sequence of stops is influenced by at least one of a value of a precondition, a mood, and information retrieved from a database.

72. The method of claim 1, wherein said content enables said agent to follow an agenda, comprising a sequence of steps.

73. The method of claim 72, wherein said sequence of steps is specified by said author.

74. The method of claim 72, wherein said sequence of steps is influenced by an interaction with a user during an operation of said agent, as specified by said author.

75. The method of claim 72, wherein said sequence of steps is influenced by at least one of a value of a precondition, a mood, and information retrieved from a database.

76. The method of claim 1 wherein said content is persona content.

77. The method of claim 1 wherein said content is application content.

78. The method of claim 1 wherein said agent engages in natural language conversation with a user, and wherein said potential context is potential conversation context, said content is conversation content, said behavior is conversation behavior, and said actual context is actual conversation context.

79. A method for authoring a computer controlled agent to play a specified role in interaction with a user, said method comprising the steps of:
a) identifying the logical structure of the interaction, comprising a sequence of interaction stages;
b) for each of said interaction stages, identifying the logical structure of the interactive behaviors of said agent and said user; and
c) for each of said logical structures of said interaction stages:
identifying a potential context of said agent for an author;
receiving a content for said agent in said potential context from said author; and
storing said content such that said content can be accessed by a run-time system that uses said content to control a behavior of said agent in an actual context, which occurs during an operation of said agent, wherein said actual context matches said potential context.

80. The method of claim 79, wherein said role is selected from the group consisting of a sales assistant role, a learning guide role, a customer service role, a messenger role, a survey administrator role, a web site host role, a game opponent role, and a marketing agent role.
